(19) United States
(12) Patent Application Publication
(10) Pub. No.: US 2015/0079565 A1
(43) Pub. Date: Mar. 19, 2015

(54) AUTOMATED INTELLIGENT MENTORING SYSTEM (AIMS)

(71) Applicant: Eastern Virginai Medical School, Norfolk, VA (US)

(72) Inventors: Geoffrey Tobias Miller, Norfolk, VA (US); Thomas W. Hubbard, Norfolk, VA (US); Johnny Joe Garcia, IV, Portsmouth, VA (US); Justin Joseph Maestri, Virginia Beach, VA (US)

(73) Assignee: Eastern Virginia Medical School, Norfolk, VA (US)

(21) Appl. No.: 14/394,026

(22) PCT Filed: Mar. 15, 2013
(86) PCT No.: PCT/US2013/032191

§ 371 Date: Oct. 10, 2014

Related U.S. Application Data
(60) Provisional application No. 61/622,969, filed on Apr. 11, 2012.

(51) Int. Cl. G09B 5/02; G09B 23/30; A63B 24/00; A63B 69/00; A63B 69/38; G09B 23/28; G06F 17/50; A63B 69/36

(52) U.S. Cl. CPC G09B 5/02; G06F 17/5009; G09B 23/30; A63B 69/36; A63B 69/0002; A63B 69/38; G09B 23/281; G09B 23/285; A63B 24/0006; A63B 2069/0008; A63B 2069/0006; A63B 2024/0012
USPC 434/252; 434/262; 434/267; 434/247; 434/322

(57) ABSTRACT

Methods, systems, and non-transitory computer program products are disclosed. Embodiments of the present, invention can include providing a performance model of a procedure, the performance model based at least in part on one or more previous performances of the procedure. Embodiments can further include obtaining performance data while the procedure is performed, the performance data based at least in pari on sensor data received from one or more motion-sensing devices. Embodiments can further include determining a performance metric of the procedure, the performance metric determined by comparing the performance data with the performance model. Embodiments can further include outputting results, the results based on the performance metric.

### CROSS-REFERENCE TO RELATED APPLICATIONS

This application claims benefit under 35 U.S.C. §119(e) of U.S. Provisional Patent Application No. 61/622,969, entitled “Automated Intelligent Mentoring System (AIMS),” filed Apr. 11, 2012, which is expressly incorporated by reference herein in its entirety.

### FIELD OF THE DISCLOSURE

The present disclosure relates generally to systems and methods for training of selected procedures, and specifically to systems and methods for training of medical procedures using at least one motion-sensing camera in communication with a computer system.

### BACKGROUND

Procedural skills teaching and assessment in healthcare are conducted with a range of simulators (e.g., part-task trainers, standardized patients, full-body computer-driven manikins, virtual reality systems, and computer-based programs) under direct mentorship or supervision of one or more clinical skills faculty members. Although this approach provides access to expert mentorship for skill acquisition and assessment, it is limited in several ways. This traditional model of teaching does not adequately support individualized learning, emphasizing deliberate and repetitive practice with formative feedback. It demands a great degree of teacher or supervisor time, and effort is directly related to class and course size. Ideal faculty:student ratios for learners are generally unrealistic for educational institutions. Finally, many skills are taught in terms of a set number of unsupervised repetitions or determined by length of practice (i.e., time), rather than in accordance to achieving skill mastery.

### SUMMARY

In accordance with the disclosed subject matter, methods, systems, and non-transitory computer program products are provided for evaluating performance of a procedure.

Certain embodiments include a method for evaluating performance of a procedure, including providing a performance model of a procedure, the performance model based at least in part on one or more previous performances of the procedure. The method further includes obtaining performance data while the procedure is performed, the performance data based at least in part on sensor data received from one or more motion-sensing devices. The method further includes determining a performance metric of the procedure, the performance metric determined by comparing the performance data with the performance model. The method further includes outputting results, the results based on the performance metric.

Certain embodiments include a system for evaluating performance of a procedure, the system including one or more motion-sensing devices, one or more displays, storage, and at least one processor. The one or more motion-sensing devices can provide sensor data tracking performance of a procedure. The at least one processor can be configured to provide a performance model of a procedure, the performance model based at least in part on one or more previous performances of the procedure. The at least one processor can be further configured to obtain performance data while the procedure is performed, the performance data based at least in part on the sensor data received from the one or more motion-sensing devices. The at least one processor can be further configured to determine a performance metric of the procedure, the performance metric determined by comparing the performance data with the performance model. The at least one processor can be further configured to output results to the display, the results based on the performance metric.

Certain embodiments include a non-transitory computer program product for evaluating performance of a procedure. The non-transitory computer program product can be tangibly embodied in a computer-readable medium. The non-transitory computer program product can include instructions operable to cause a data processing apparatus to provide a performance model of a procedure, the performance model based at least in part on one or more previous performances of the procedure. The non-transitory computer program product can further include instructions operable to cause a data processing apparatus to obtain performance data while the procedure is performed, the performance data based at least in part on sensor data received from one or more motion-sensing devices. The non-transitory computer program product can include instructions operable to cause a data processing apparatus to determine a performance metric of the procedure, the performance metric determined by comparing the performance data with the performance model. The non-transitory computer program product can further include instructions operable to cause a data processing apparatus to output results, the results based on the performance metric.

The embodiments described herein can include additional aspects of the present invention. For example, the determining the performance model can include aggregating data obtained from monitoring actions from multiple performances of the procedure. The performance data can include user movements, the sensor data received from the one or more motion-sensing devices can include motion in at least one of an x, y, and z direction received from a motion-sensing camera, and the comparing the performance data with the performance model can include determining deviations of the performance data from the performance model. The obtaining the performance data can include receiving sensor data based on a position of a simulation training device, and the simulation training device can include a medical training mannequin. The obtaining the performance data can include receiving sensor data based on a relationship between two or more people. The obtaining the performance data can include determining data based on a user's upper body area while the user's lower body area is obscured. The procedures can include at least one of endotracheal intubation by direct laryngoscopy, intravenous starts, bladder catheter insertion, arterial blood collection for blood gas measurement, incision and drainage, cutaneous injections, joint aspirations, joint injections, lumbar puncture, nasogastric tube placement, electrocardiogram lead placement, tendon reflex assessment, vaginal delivery, wound closure, venipuncture, safe patient lifting and transfer, physical and occupational therapies, equipment assembly, equipment calibration, equipment repair, safe equipment handling, baseball batting, baseball pitching, golf swings, golf putts, racquetball strokes, squash strokes, and tennis strokes.

### BRIEF DESCRIPTION OF THE DRAWINGS

Various objects, features, and advantages of the present disclosure can be more fully appreciated with reference to the following detailed description when considered in connection with the following drawings, in which like reference numerals identify like elements. The following drawings are for the purpose of illustration only and are not intended to be limiting of the invention, the scope of which is set forth in the claims that follow.

FIG. 1 illustrates a non-limiting example of a system for training of a procedure in accordance with certain embodiments of the present disclosure.

FIGS. 2A-2C illustrate examples of screenshots of a user interface for providing feedback for a procedure in accordance with certain embodiments of the present disclosure.

FIG. 3 illustrates an example block diagram of stages or segments that the system can use for evaluating performance of a procedure in accordance with certain embodiments of the present disclosure.

FIG. 4 illustrates an example of a method that the system performs for evaluating performance of a procedure in accordance with certain embodiments of the present disclosure.

FIG. 5A illustrates an example block diagram of providing a performance model of a procedure in accordance with certain embodiments of the present disclosure.

FIG. 5B illustrates an example of the method that the system performs for providing a performance model of a procedure in accordance with certain embodiments of the present disclosure.

FIG. 6 illustrates an example of sensor data that the system obtains while a procedure is performed in accordance with certain embodiments of the present disclosure.

FIG. 7 illustrates an example of performance data that the system determines while a procedure is performed in accordance with certain embodiments of the present disclosure.

FIG. 8 illustrates an example of tracking multiple users in accordance with certain embodiments of the present disclosure.

FIG. 9 illustrates an example of a method that the system performs for evaluating performance of a procedure in accordance with certain embodiments of the present disclosure.

FIGS. 10A-10B illustrate example screenshots of a user interface for interacting with the system in accordance with certain embodiments of the present disclosure.

FIG. 11 illustrates an example screenshot of a user interface for calibrating the system in accordance with certain embodiments of the present disclosure.

FIG. 12 illustrates an example screenshot of a user interface for displaying a student profile in accordance with certain embodiments of the present disclosure.

FIG. 13 illustrates an example screenshot of a user interface for selecting a training module in accordance with certain embodiments of the present disclosure.

FIGS. 14A-14B illustrate example screenshots of a user interface for reviewing individual user results in accordance with certain embodiments of the present disclosure.

FIG. 15 illustrates a screenshot of an example user interface for a course snapshot administrator view for a procedure in accordance with certain embodiments of the present disclosure.

FIG. 16 illustrates a screenshot of an example user interface for an individual participant overview administrator view for a procedure in accordance with certain embodiments of the present disclosure.

FIG. 17 illustrates a screenshot of an example user interface for an individual participant detail view administrator view for a procedure in accordance with certain embodiments of the present disclosure.

FIG. 18 illustrates a screenshot of an example user interface for an individual event detail view administrator view for a procedure in accordance with certain embodiments of the present disclosure.

### DETAILED DESCRIPTION

In general, the present disclosure includes systems and methods for improved training and assessment (formative and summative) of a procedure. Example procedures can include endotracheal intubation by direct laryngoscopy, safe patient handling or a number of other procedures. The present systems and methods evaluate performance of a procedure using a motion-sensing camera in communication with a computer system. An example system includes providing a performance model of a procedure. The performance model can be based on data gathered from one or more previous performances of the procedure, including data determined from subject matter experts such as clinical skills faculty members or practicing physicians. The present method obtains performance data while the procedure is performed. Example performance data can include body positioning data, motion accuracy, finger articulation, placement accuracy, object recognition, object tracking, object-on-object pressure application, variances in object shape, 3D zone validation, time-to-completion, body mechanics, color tracking, verbal input, facial recognition, and head position, obtained while a user performs the procedure. The performance data can be based on sensor data received from any motion-sensing device capable of capturing real-time spatial information. A non-limiting example motion-sensing device is a motion-sensing camera. Example sensor data can include color components such as red-green-blue (RGB) video, depth, spatial position in x, y, or z, or motion in an x, y, or z direction, acoustic data such as verbal input from microphones, head tracking, gesture recognition, or feature recognition such as line segments modeling a user's virtual “skeleton.” The present system determines a performance metric of the procedure by comparing the performance data with the performance model. Based on the performance metric, the present system outputs results. Example output can include displaying dynamic data, for example while the user performs a procedure or after the user has performed the procedure.

The present systems and methods teach and assess procedural skills to provide performance modeling and training. Example procedural skills can include endotracheal intubation, safe patient handling, peripheral intravenous line placement, nasogastric tube placement, reflex testing, etc. The present system involves real-time, three dimensional mapping and objective-based measurement, and assessment of individual performance of a procedure against performance models based on expert performances. In some embodiments, the present system uses commercially available hardware, including a computer and at least one motion-sensing camera. For example, the present system can use KINECT® motion-sensing cameras from MICROSOFT® Corporation in Redmond, Wash., USA.

The present system teaches and assesses procedural clinical skills, and tasks involving deliberate body mechanics (e.g., lifting and/or moving patients). Unlike traditional simulation training models, the present system provides audio-based procedural instruction and active visual cues, coupled with structured and supported feedback on the results of each session. The present system greatly enhances the ability to support direct, standardized “expert” mentorship. For example, health professionals can learn and acquire new procedural clinical skills or be assessed in their proficiency in performing procedural skills.

The present system allows students to be “mentored” without supervisors, gives prescriptive, individualized feedback, and allows unlimited attempts at a procedure necessary for an individual learner to achieve a designated level of competency. All of this can lower the expense of faculty time and effort. Unlike traditional simulation training models that require on-site teachers and often one-on-one interaction between learner and teacher, the present systems and methods substantially reduce the need for continuous direct supervision while facilitating more accurate and productive outcomes. The present system standardizes the teaching process, reducing variability of instruction. The present system uses readily accessible hardware components that can be assembled with minimal costs. The present systems and methods provide comprehensive, real-time interactive instruction including active visual cues, and dynamic feedback to users.

The present systems and methods allow standardized on-time, on-demand instruction, assessment information and prescriptive feedback, and an opportunity to engage in deliberate and repetitive practice to achieve skill mastery. In contrast, traditional hands-on teacher observation and evaluation requires high expense of faculty time and effort. An economic advantage of the present systems and methods is a reduction of teacher, supervisor, or evaluator time commitment while also expanding the opportunity for deliberate and repetitive practice. Economic impact of the present system to train users to a level of proficiency without expensive investment of teacher time has enormous potential. Efficient redeployment of teacher resources and a guarantee of learner proficiency can result in a positive return on investment. Traditional one-on-one supervision can be resource-intensive, and involvement can be extensive with some learners who achieve competency at slower rates. The present system provides unlimited opportunities to achieve mastery to students who can work on their own, and who would otherwise require many attempts. Once learners achieve a designated level of competency according to assessment by the present system, the learners may be evaluated by a faculty supervisor. Accordingly, the present system improves efficiency because learners sitting for faculty evaluation should have met standards set by the present system. The present system reduces the number of learners who, once officially evaluated, need remediation. The present system can also serve a remediation junction, as well as maintenance of certification or competence.

Potential customers to deploy the present systems and methods include institutions or programs, which invest in live education with the purpose of achieving or maintaining procedural skill competency amongst their learners. Advantageously, the present system provides an accessible, easy-to-use user interface at a low price. Potential cost savings depend on time-to-mastery of a procedure, and related teacher time dedicated to supervision. For a complex skill such as endotracheal intubation, for example—as with many clinical procedural skills in medicine and healthcare—the time and effort requirement of faculty supervision is enormous. The present systems and methods can be used in education, skill assessment, and maintenance of competence. Example subscribers can include medical and health professions schools, entities that certify new users or maintenance of skills, health care provider organizations, and any entity that trains, monitors, and assesses staff, employees, and workers in procedures which can be tracked and analyzed by the present systems and methods. The present systems and methods can be attractive to an expanding health care industry that is focused on efficient and timely use of resources, heightened patient safety, and reduction in medical mishaps.

The present systems and methods have a three-part aim: satisfy growing needs of the medical community, provide a product to effectively improve skills and attain procedural mastery, and increase interest in simplified methods of training by providing a smart return on investment. The present system addresses procedural training needs within the health care community. The present system provides live feedback and detailed comparison of a user's results with curriculum-mandated standards. With feedback and unlimited opportunity to practice a procedure with real-time expert mentorship, a learner can achieve expected proficiency at his or her own pace. The present system is a cost-effective way to eliminate inconsistencies in training methods and assessment, and to reduce mounting demands on expert clinical educators. These advantages are achieved through low-cost hardware and a software package that, in an embodiment, is provided through a subscription from an Internet- or online-based environment.

The present systems and methods provides healthcare professionals, students, and practitioners with a way to learn and perfect key skills they need to attain course objectives, recertification, or skills maintenance. The present systems and methods enhance deliberate and repetitive practice necessary to achieve skill mastery, accelerate skill acquisition since supervision and scheduling are minimized, and provide uniformity in training and competency assessments. These advantages can be achieved by leveraging and combining certain hardware and/or software modules with existing simulation training equipment, computers, and a motion capture system including one or more motion-sensing cameras.

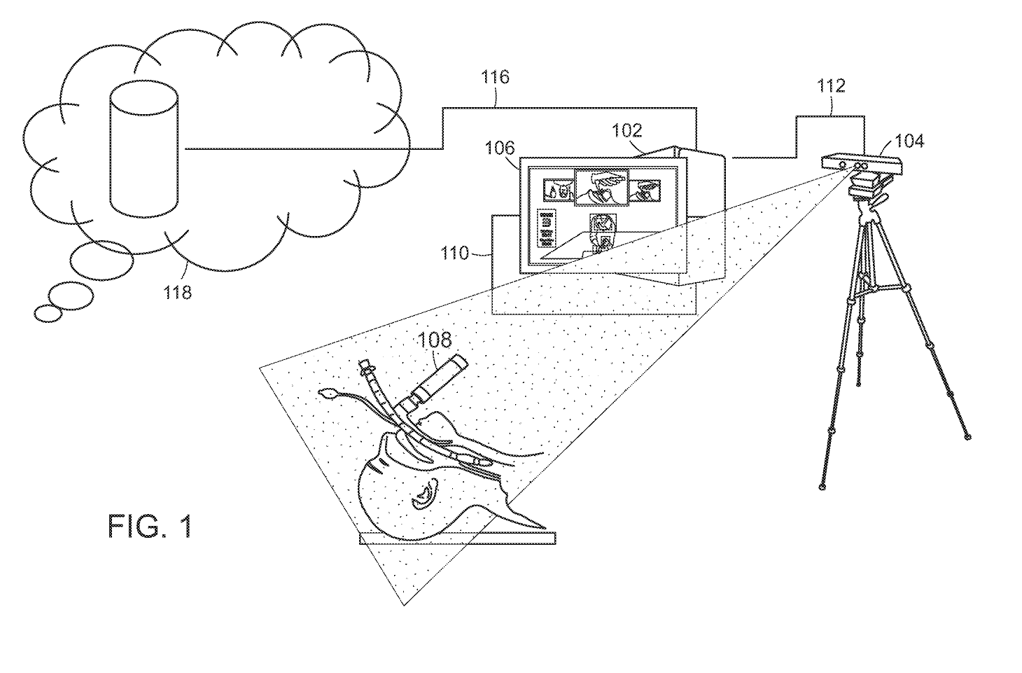

Turning to the figures, FIG. 1 illustrates a non-limiting example of a system 100 for training of a procedure in accordance with certain embodiments of the present disclosure. System 100 includes a computer 102, a motion-sensing camera 104, and a display 106. In some embodiments, system 100 can measure and track movements such as hand movements in relation to optional static task trainers or optional simulation training devices. Simulation training devices, as used in healthcare, refer to devices that are anatomically accurate and designed to have simulated procedures performed on them. Non-limiting example optional devices can include an airway trainer 108 for endotracheal intubation. Of course, devices for use are not limited to airway trainers and can include other static task trainers or simulation training devices. Simulation devices may also be unrelated to medical training or health care. Simulation devices can include medical tools such as ophthalmoscopes, otoscopes, scalpels, stethoscopes, stretchers, syringes, tongue depressors, or wheelchairs; laboratory equipment such as pipettes or test tubes; implements used in manufacturing or repair that may include tools used by hand, such as hammers, screwdrivers, wrenches, or saws, or even sports equipment such as baseball bats, golf clubs, or tennis racquets. System 100 provides detailed analysis and feedback to the learner, for example via display 106. In some embodiments, computer 102 and display 106 can be in a single unit, such as a laptop computer or the like.

Camera 104 tracks and measures movements such that it can accurately and precisely record motion of a user attempting a procedure. Example motion-sensing cameras can include KINECT® motion-sensing cameras from MICROSOFT® Corporation. Of course, as described earlier, the present system is not limited to using motion-sensing cameras and is capable of using sensor data from any motion-sensitive device. Example motion-sensing devices can include a Myo muscle-based motion-sensing armband from Thalmic Labs, Inc. in Waterloo, Canada, or motion-sensing controllers such as a Leap Motion controller from Leap Motion, Inc. in San Francisco, Calif., United States of America, a WII® game controller and motion-sensing system from Nintendo Co., Ltd. in Kyoto, Japan, or a PLAYSTATION®MOVE game controller and motion-sensing system from Sony Corporation in Tokyo, Japan. Camera 104 captures sensor data from the user's performance. In some embodiments, the sensor data can include color components such as a red-green-blue (RGB) video stream, depth, or motion in an x, y, or z direction. Example sensor data can also include acoustic data such as from microphones or verbal input, head tracking, gesture recognition, or feature recognition such as line segments modeling a user's virtual “skeleton.”

Computer 102 analyzes sensor data received from camera 104 to obtain performance data of the user performing the procedure, and uses the performance data to determine a performance metric of the procedure and output results. Computer 102 receives sensor data from camera 104 over interface 112. Computer 102 provides accurate synchronous feedback and detailed comparisons of the user's recorded performance metrics with previously established performance models. For example, computer 102 can formulate a performance score and suggest steps to achieve a benchmark level of proficiency. Computer 102 can communicate with display 106 over interface 110 to output results based on the performance score, or provide other dynamic feedback of the user's performance.

In some embodiments, modules of system 100 can be implemented as an optional Software as a Service (SaaS) cloud-based environment 118. For example a customer or client can select for system 100 to receive data from a server-side database, or a remote data cloud. In some embodiments, system 100 allows a customer or client to store performance data in the cloud upon completion of each training exercise or procedure. Accordingly, cloud-based environment 118 allows certain aspects of system 100 to be sold through subscription. For example, subscriptions can include packages from a custom Internet- or Web-based environment, such as a menu of teaching modules (or procedures) available through a subscription service. System 100 is easily updatable and managed from a securely managed cloud-based environment 118. In some embodiments, cloud-based environment 118 can be compliant with legal requirements such as the Health Insurance Portability and Accountability Act (HIPAA), the Health Information Technology for Economic and Clinical Health (HITECH) Act, and/or the Family Educational Rights and Privacy Act (FERPA). Subscriptions can be offered via a menu of procedures in an applications storefront over the Internet. Users receive sustainable advantages from a subscription-based service. First is the ease of updating software in cloud-based environment 118, for example to receive feature upgrades or security updates. Additionally, cloud-based environment 118 featuring SaaS allows system 100 versatility to adapt to future learning and training needs, by adding products or modules to an application store. The present system also allows distribution channel selection via SaaS. Distribution channel selection allows the present system to be easily updated and refined as subscription libraries expand.

For example, the processing described herein and results therefrom can be performed and/or stored on and retrieved from remote systems. In some embodiments, computer 102 can be remote from display 106 and camera 104, and interfaces 110, 112, and 116 can represent communication over a network. In other embodiments, computer 102 can receive information from a remote server and/or databases accessed over a network such as cloud-based environment 118 over interface 116. The network may be a single network or one or more networks. As described earlier, the network may establish a computing cloud (e.g., the hardware and/or software implementing the processes and/or storing the data described herein are hosted by a cloud provider and exists “in the cloud”). Moreover, the network can be a combination of public and/or private networks, which can include any combination of the Internet and intranet systems that allow system 100 to access storage servers and send and receive data. For example, the network can connect one or more of the system components using the Internet, a local area network (LAN) such as Ethernet or Wi-Fi, or wide area network (WAN) such as LAN-to-LAN via Internet tunneling, or a combination thereof, using electrical cable such as HomePNA or power line communication, optical fiber, or radio waves such as wireless LAN, to transmit data. In this regard, the system and storage devices may use standard Internet protocols for communication (e.g., iSCSI). In some embodiments, system 100 may be connected to the communications network using a wired connection to the Internet.

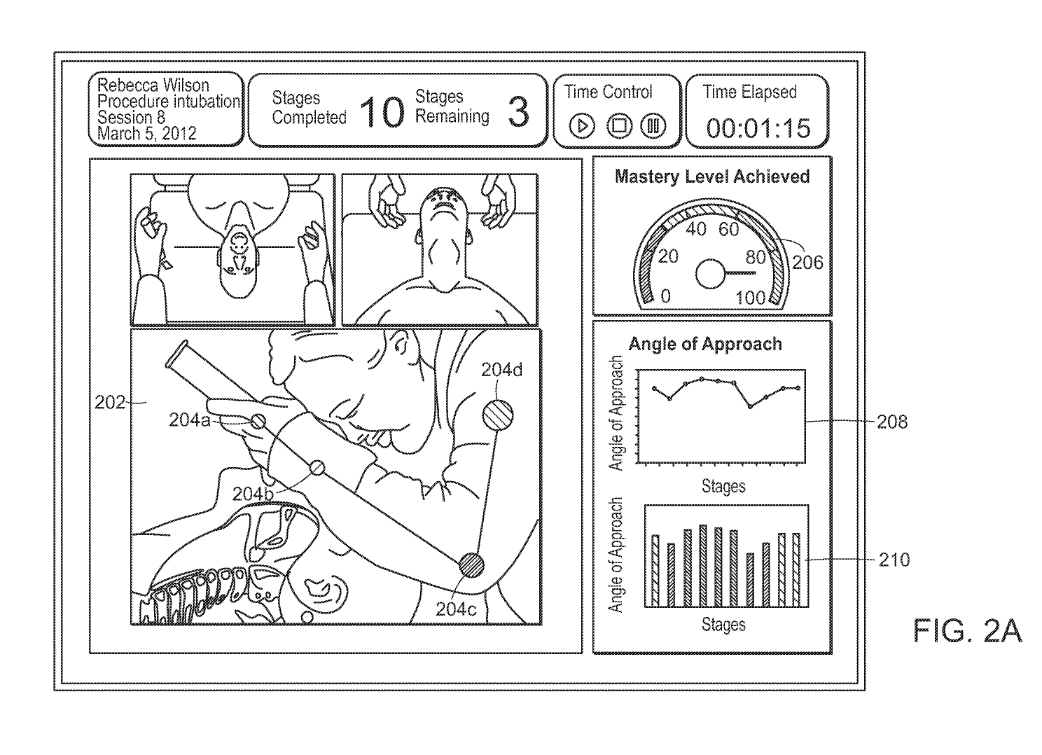

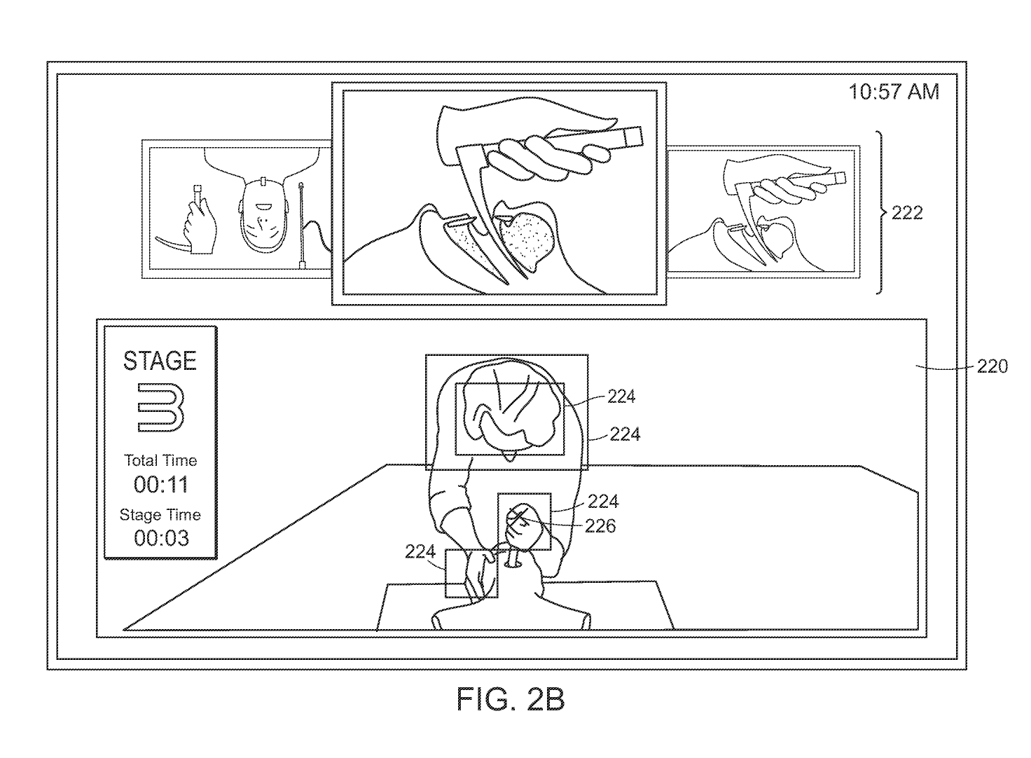

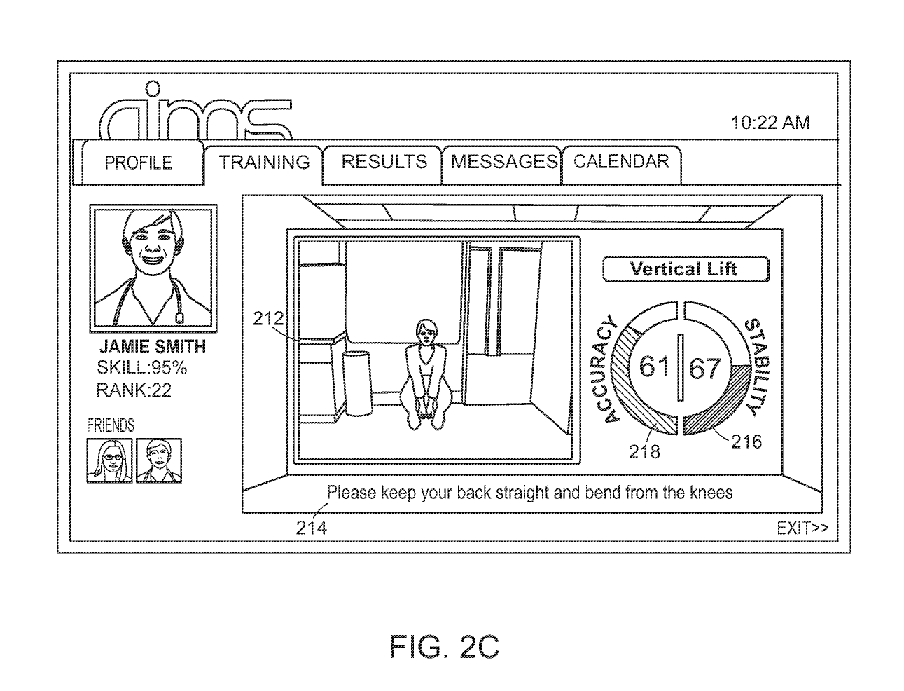

FIGS. 2A-2C illustrate examples of screenshots of a user interface for providing feedback for a procedure in accordance with certain embodiments of the present disclosure.

FIG. 2A illustrates a screenshot of a template for user feedback while the user performs an endotracheal intubation by direct laryngoscopy procedure. With feedback, the learner can repeat the task until achieving a measured level of proficiency. Without the need for supervision, and allowing unlimited tries to reach proficiency, the present system allows learners to proceed at their own pace of learning and fitting their own scheduling needs. The present system requires little or no teacher supervision, and teaches a procedure in a uniform manner, and according to individualized needs of the learner.

For example, the user interface may include a real-time video feed 202, a mastery level gauge 206, and a line graph 208 and bar graph 210 tracking the user's angle of approach. FIG. 2A illustrates a user practicing endotracheal intubation by direct laryngoscopy. Real-time video feed 202 (showing a student intubating a mannequin) illustrates a display overlaid on the real-time video feed of certain performance data indicating the student's body and joint position. In use, the present system monitors movements and provides a real-time video feed of the user on the display. If the user positions or moves herself improperly, the present system alerts the user. Example output can include changes in color on the screen, audible signals, or any other type of feedback that the user can hear or see to learn that the movement was improper. As the user is performing the procedure, this performance data allows the present system to train a user to improve her accuracy of motion. For example, real-time video feed 202 indicates position 204a of the user's hand and position 204d of the user's shoulder are good, position 204b of the user's wrist is satisfactory, and position 204c of the user's elbow needs improvement. In some embodiments, the present system can display good positions in green, satisfactory positions in yellow, and positions needing improvement in red.

In some embodiments, the output results can also include gauges reflecting performance metrics. The present system can divide a procedure into segments. For example, gauge 206 indicates the user has received a score of about 85% mastery level for the current segment or stage of the procedure. In some embodiments, the output results can also include line graphs and/or bar graphs that display accuracy of the current segment or stage of the training exercise or training module. For example, line graph 208 indicates a trend of the user's performance based on angle of approach during each segment or stage of the training exercise or training module. Similarly, bar graph 210 indicates a histogram of the user's performance based on angle of approach during each segment or stage of the training exercise or training module. In further embodiments, the line graphs and/or bar graphs can also track time-to-completion of each segment or stage of the training exercise, or of the current training exercise overall. In still further embodiments, the line graphs and/or bar graphs can include histograms of progress over time, and overall skill mastery over time.

FIG. 2B illustrates a screenshot of an alternate template for user feedback while the user performs an endotracheal intubation by direct laryngoscopy procedure. For example, the user interface may include real-time video feed 220, stages or segments 222, and zones of accuracy 224. In some embodiments, the present system can divide a procedure into segments. Each segment can assist the user by including a figure or other depiction indicating how the operation should be performed. Stages or segments 222 can display previous and next stages or segments of the procedure or training module. For example, the present system may display a picture of a user inserting an airway trainer. Of course, the present system may display text instructing the user and/or may provide audible instructions. Real-time video feed 220 can also display overlays depicting color-coded zones of accuracy 224. In some embodiments, color-coded 3D zones of accuracy allow the present system to recognize predetermined zones, areas, or regions of accuracy and/or inaccuracy on a specific stage or segment of a course.

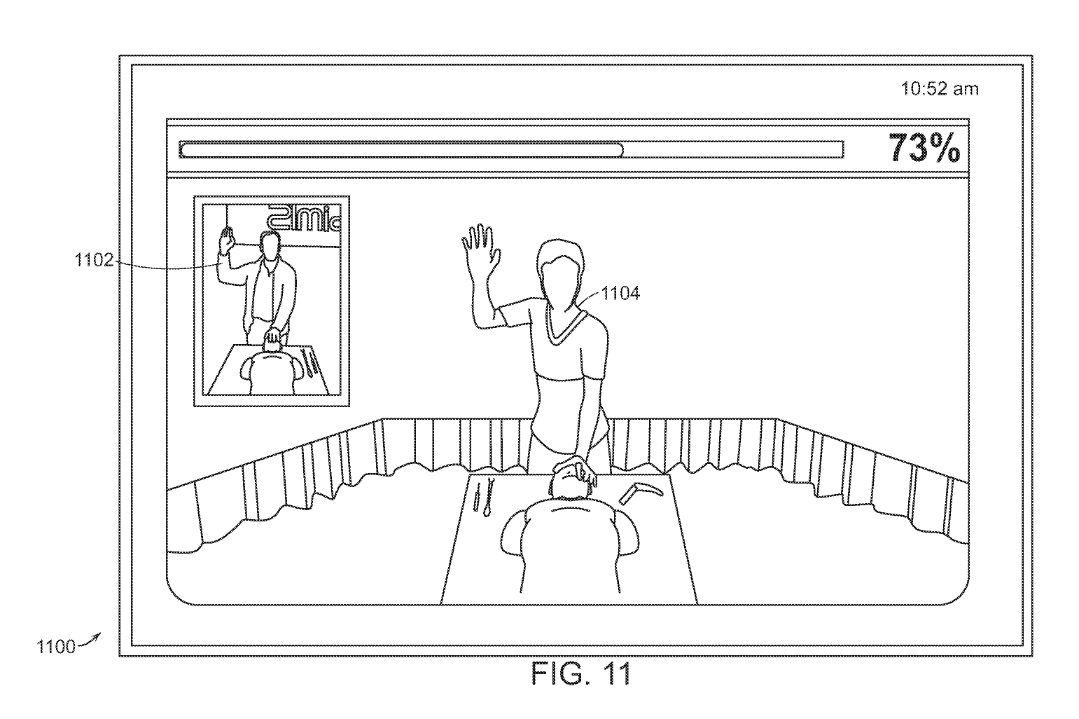

The zones of accuracy can be determined in relation to a user's joints and/or optional color labeled instrument. An optional color labeled instrument is illustrated by an “X” 226 to verify that the present system is in fact tracking and recognizing the corresponding color. In some embodiments, the present system can use “blob detection” to track each color. The present system looks at a predefined color in a specific area of the physical space and locks onto that color until it fulfills the need of that stage or set of stages to capture the user's performance. For example, as illustrated in FIG. 2B, an administrator can predefine that the present system should track the color yellow for the duration of stage 3 of the endotracheal intubation procedure. Since the optional instrument is labeled with an “X” colored yellow, the present system tracks the optional instrument for the duration of stage 3. In further embodiments, the present system can calibrate the predetermined colors to account for variations in lighting temperature. The present system can calibrate the predetermined colors during a user calibration phase of the procedure (shown later in FIG. 11), or at other specified stages during the procedure.

As illustrated by zones of accuracy 224, the present system is able to display detected zones of accuracy and inaccuracy for a user to evaluate whether his tracked body position and/or instrument are located substantially within a generally correct area. Each zone of accuracy is part of a performance model determined by aggregating data collected from Subject Matter Experts (SMEs). The aggregated data is broken into stages with various 3D zones, predefined paths and movement watchers. Predefined paths refer to paths of subject matter expert body mechanics determined in a performance model, in the form of an angle of approach or sweeping motion. The present system uses predefined paths as a method of accuracy measurement to measure the user's path against a predefined path of the subject matter expert stored within the present system, in relation to that particular segment. Watchers refer to sets of joint or color variables that trigger when a user progresses from one stage to another. Therefore the present system can set watchers to act as validators, to ensure the present system has not missed a stage advancement event. If a stage advancement event were to occur, the present system could use path tracking information from the previous stage to determine last known paths before the next stage's watcher is triggered.

In some embodiments, the zones of accuracy, predefined paths, and movement watchers in the performance model can be compared with performance data from the user relative to a zero point determined during an initial calibration stage (shown in FIG. 11).

Each predetermined zone of accuracy can be imagined as a floating tube or block, hovering in the mirror image of a virtual space of the user, as illustrated in FIG. 2B. The user's movement in physical space allows a virtual representation of the user to move through these 3D zones of accuracy based on analysis and refinement of raw sensor data from the motion-sensitive camera including the data stream of information being collected from the user's body mechanics and optional instruments being tracked, and based on the performance data being determined based on the sensor data. The present system then determines intersection points or areas where a position of the user's movements intersects the 3D zones of accuracy. The present system can use these intersections to determine a performance metric such as accuracy of the user within the virtual zones of accuracy on the x-, y-, or z-axes.

The present system can further determine performance data including measures based on physics. For example, the present system can determine performance data including pressure applied to a simulation training device, and/or forward or backward momentum applied to the simulation training device, based on determining a degree to which the user moves an optional instrument forward or backward on the z-axis. The user could also move up and down on the y-axis, which would allow the present system to determine general zones of accuracy on the vertical plane. The user could also move the optional instrument side-to-side on the X-axis, which would allow the present system to determine positional zones of accuracy on the horizontal plane.

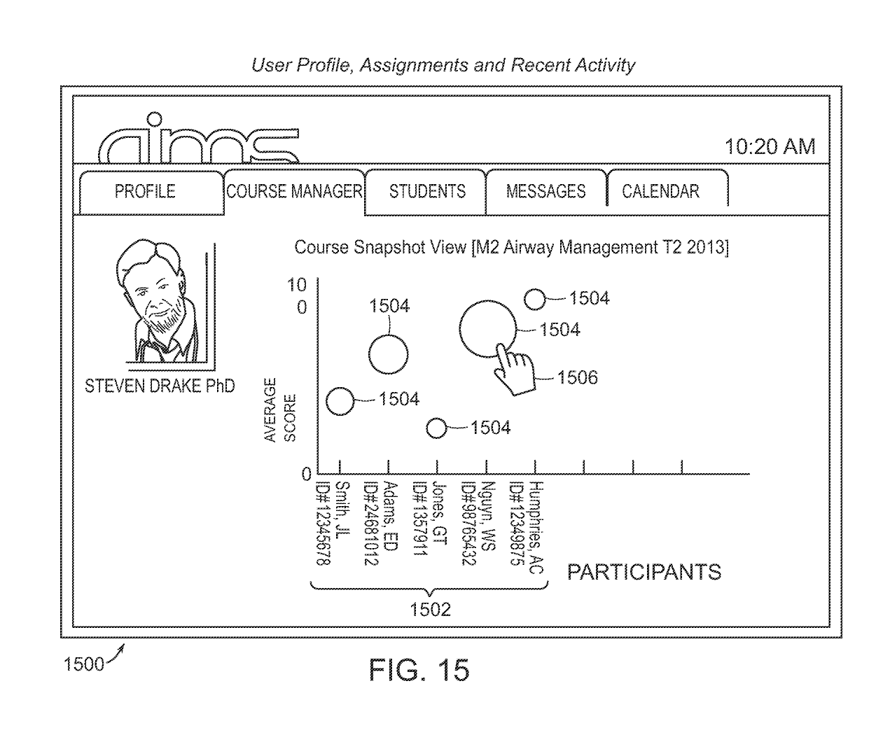

In some embodiments, the present system can output results by displaying performance metrics such as color-coding zones of accuracy as red, yellow, or green. Red can indicate incorrect movement or placement. Yellow can indicate average or satisfactory movement or placement. Green can indicate good, excellent, or optimal movement or placement. The present system can allow users and administrators to review color-coded zones of accuracy in results pages (shown in FIG. 15).

FIG. 2C illustrates a screenshot of a template for user feedback while the user performs a safe patient handling procedure. For example, the user interface may include a real-time video feed 212, instructions 214 for each segment or stage, and gauges 216, 218 for displaying output results based on performance metrics. The safe patient handling procedure and other human procedures, such as physical diagnosis maneuvers, physical therapy actions and the like, may not necessarily involve a tool or handheld device.

As described earlier, the present system can be applied to procedures without devices or tools, and can be applied in domains and industries outside the medical or healthcare profession. Each year people in the United States suffer a workplace injury or occupational illness. Nursing aides and orderlies often suffer the highest occupational prevalence and constitute the highest annual rate of work-related back pain in the United States, especially among female workers. Direct and indirect costs associated with back injuries in the healthcare industry reach into the billions annually. As the nursing workforce ages and a critical nursing shortage in the United States looms, preserving the health of nursing staff and reducing back injuries in healthcare personnel becomes critical. Nevertheless, it will be appreciated that embodiments of the present system can be applied outside the medical or healthcare profession.

Real-time video feed 212 can show a color-coded overlay per tracked area of the user's skeleton, or an overlay showing human-like model performance. The overlays can indicate how the user should be positioned during a segment or stage of a safe patient handling procedure. Each segment can assist the user by including a figure or other depiction indicating how the operation should be performed. For example, at the beginning of a training session, the present system may display text instructing the user, and/or a picture instructing a user. For example, instructions may include text instructing the user to pick up the medical device, and/or a picture of a user picking up a medical device. Of course, the present system may also provide audible instructions. Instructions 214 include text instructing the user to “[p]lease keep your back straight and bend from the knees.” Gauges 216, 218 illustrate output results corresponding to performance metrics of accuracy and stability. For example, gauge 216 indicates the user has a proficiency score of 67 rating her stability. Similarly, gauge 218 indicates the user has a proficiency score of 61 rating her accuracy.

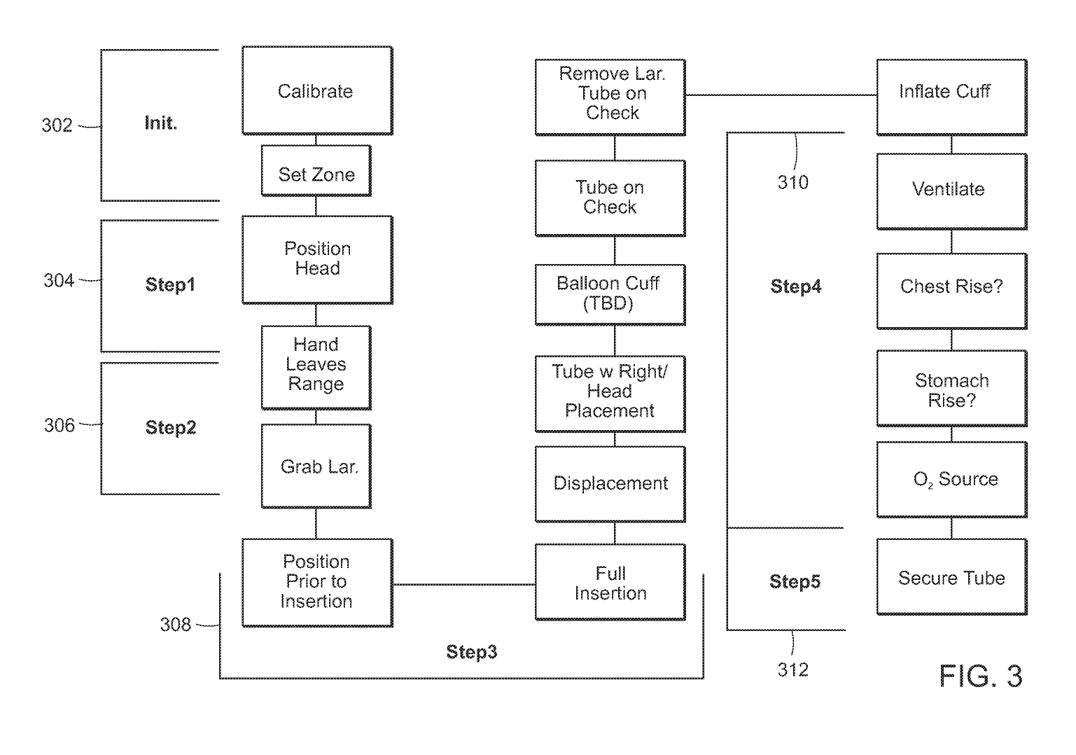

FIG. 3 illustrates an example block diagram of stages or segments that the system can use for evaluating performance of a procedure in accordance with certain embodiments of the present disclosure. As described earlier, the present system can be configured to divide a procedure into segments, stages, or steps. For example, an initialization step 302 can include calibrating the system (shown in FIG. 11) and determining zones of accuracy based on the calibration. A step 1 (304) can include instructing a user to position a head of a mannequin or other simulation-based training device, and determining whether a user's hand leaves a range of the mannequin's head. A step 2 (306) can include determining that the hand has left the range of the mannequin's head and determining when the user has picked up a laryngoscope. A step 3 (308) can include evaluating the user's position prior to insertion of the laryngoscope, evaluating full insertion of the laryngoscope, evaluating any displacement of the laryngoscope, evaluating whether head placement of the mannequin is proper, evaluating inflating a balloon cuff, checking that the tube is on, evaluating removal of the laryngoscope tube upon the check, and evaluating inflation of the cuff. A step 4 (310) can include evaluating ventilation of the mannequin, evaluating chest rise of the mannequin, evaluating stomach rise of the mannequin, and evaluating an oxygen source of the mannequin. A step 5 (312) can include evaluating securing of the laryngoscope tube.

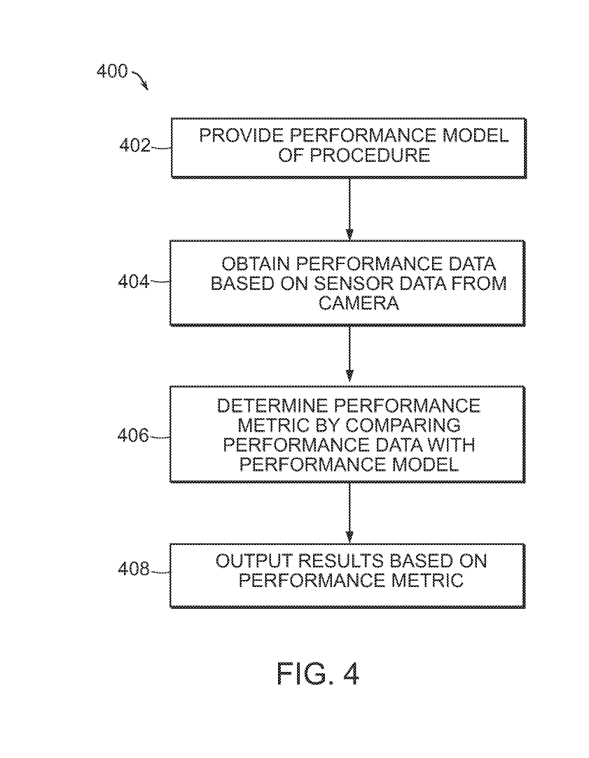

FIG. 4 illustrates an example of a method 400 that the system performs for evaluating performance of a procedure in accordance with certain embodiments of the present disclosure. The present disclosure includes methods for improved training of a procedure. Example procedures can include endotracheal intubation by direct laryngoscopy, safe patient handling, or a number of other procedures. Additional procedures, by way of explanation and not limitation, may include training for manufacturing processes, athletic motion, including golf swing analysis and the like. Embodiments of the invention may be used for any procedure that requires accurate visual monitoring of a user to provide feedback for improving motion and technique.

Method 400 provides a performance model of a procedure (step 402). The performance model can be based on data gathered from one or more previous performances of the procedure, including data determined from subject matter experts such as clinical skills faculty members or practicing physicians. The performance model can also be based on external sources. Non-limiting examples of external sources can include externally validated ergonomic data, for example during a safe patient handling procedure. The present method obtains performance data while the procedure is performed (step 404). In some embodiments, the performance data can be obtained while a user performs the procedure. Example performance data can include body positioning data, motion accuracy, finger articulation, placement accuracy, object recognition, zone validation, time-to-completion, skeletal joint, color, and head position. The performance data can be based on sensor data received from a motion-sensing camera. As described earlier, example sensor data received from the motion-sensing camera can include color components such as red-green-blue (RGB), depth, and position or motion in an x, y, or z direction. Example sensor data can also include acoustic data such as from microphones or voice recognition, or facial recognition, gesture recognition, or feature recognition such as line segments modeling a user's virtual “skeleton.” Method 400 determines a performance metric of the procedure by comparing the performance data with the performance model (step 406). Based on the performance metric, the present system outputs results (step 408). Example output can include displaying dynamic feedback, for example while the user performs a procedure, or after the user has performed the procedure,

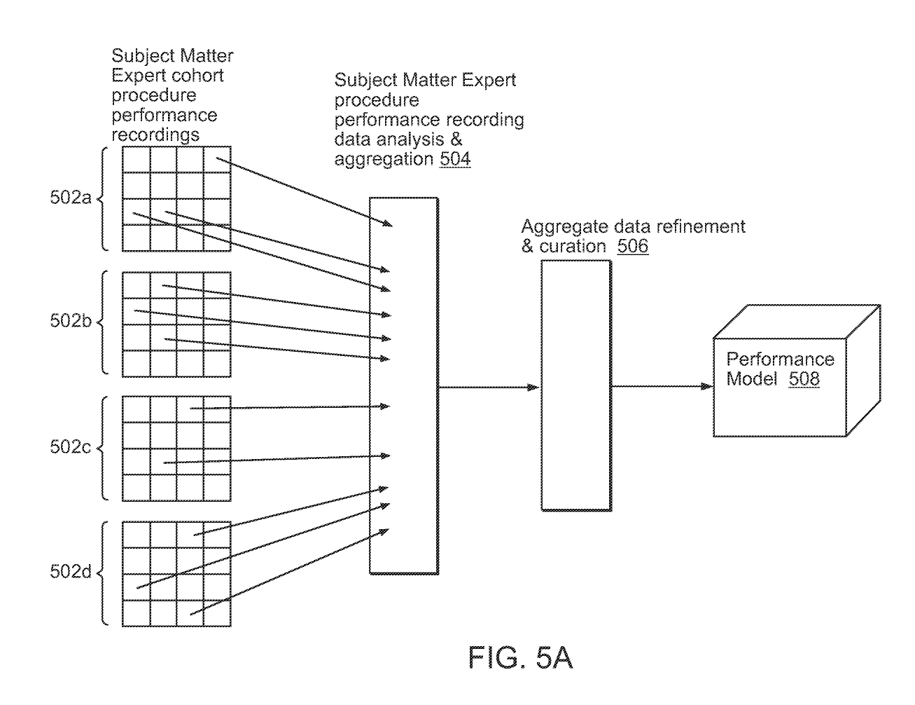

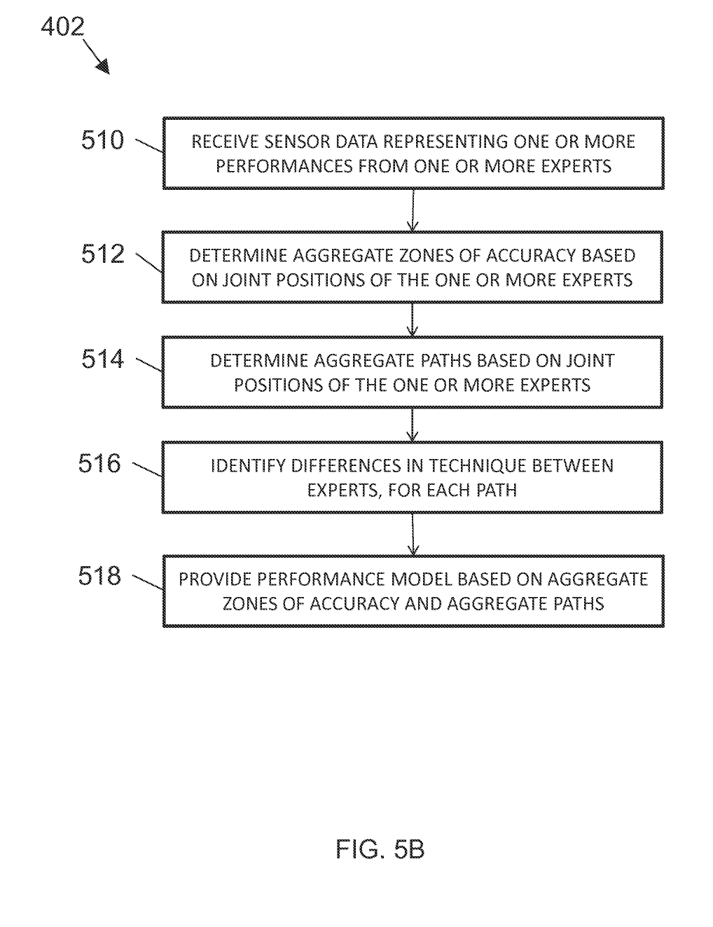

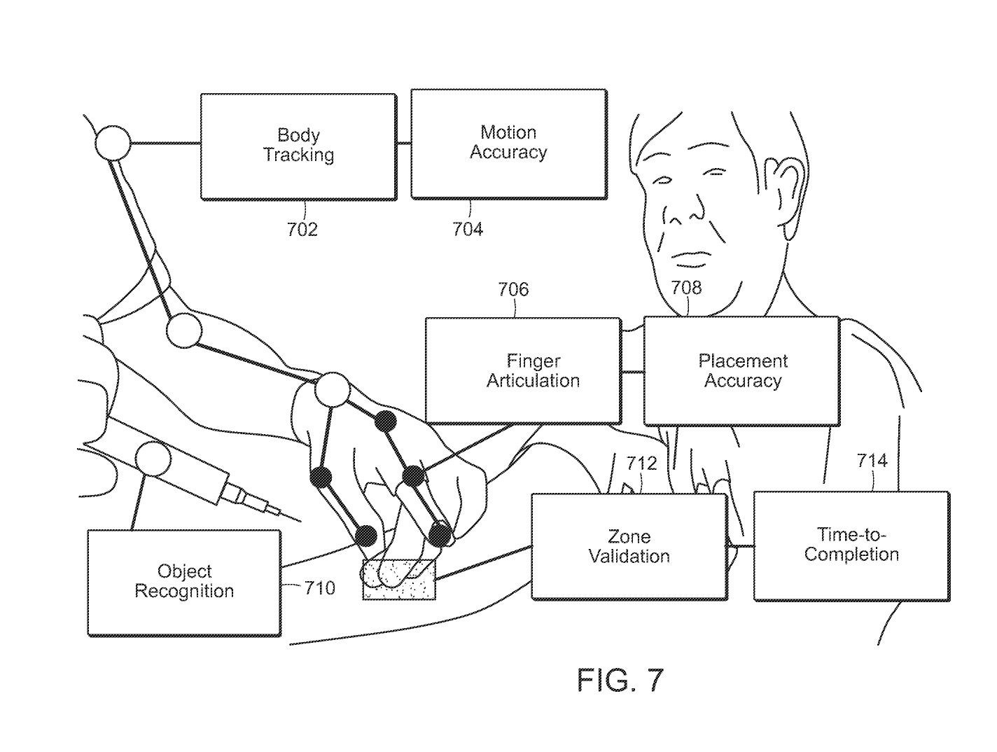

FIG. 5A illustrates an example block diagram of providing a performance model of a procedure in accordance with certain embodiments of the present disclosure. After soliciting subject matter experts for a desired procedure and field, the present system records multiple performances 502a-d by each subject matter expert. In some embodiments, the present system determines performance data for subject matter experts based on sensor data received from the motion-sensing camera. The performance data can be determined in a manner similar to determining performance data for users (shown in FIG. 7). The recording process can be repeated for each member of a cohort. For example, twenty subject matter experts can be recorded performing a procedure fifty times each.

The present system then aggregates the performance data 504 for the subject matter experts. The present system uses the aggregated data to determine averages and means of skill performance for a procedure. For example, the aggregated data can include zones of accuracy, joint paths, and optional tool paths. The present system then refines and curates the aggregate data 506 to produce a performance model 508. In some embodiments, the present system can also incorporate external sources into performance model 508. As described earlier, the present system can incorporate published metrics such as published ergonomic data for safe patient handling procedures. As described earlier, the performance model can be used to compare performance of users using the present system. In some embodiments, the performance model can include zones of accuracy, joint paths, and optional tool paths based on aggregate performances by the subject matter experts.

FIG. 5B illustrates an example of the method 402 that the system performs for providing a performance model of a procedure in accordance with certain embodiments of the present disclosure. In general, the present system determines a performance model based on example performances from a subject matter expert performing a procedure multiple times. For example, five different subject matter experts may each perform a procedure twenty times while being monitored by the present system. Of course, more or fewer experts may be used and each expert may perform a procedure more or less times while being monitored by the present system. In some embodiments, the present system determines a performance model by averaging performance data gathered from monitoring the subject matter experts. Of course, many other methods are available to combine the performance data gathered from monitoring the subject matter experts, and averaging is merely one way to combine performance data from multiple experts.

The present system receives sensor data representing one or more performances from one or more experts (step 510). For example, the present system can receive sensor data from the motion-sensitive camera based on a recording of one or more subject matter experts for each stage or segment of a procedure. If more than one expert is recorded, the body placement of each expert will vary, for example due to differences in body metrics such as height and/or weight.

The present system determines aggregate zones of accuracy (step 512). For example, the present system can identify joint positions and tool placements (both in 2D and 3D space) for each expert at the same point during a procedure, for example by correlating when the experts complete a stage or segment. The present system can identify joint positions and/or tool placements for each stage in a procedure. The present system can then average the locations of joint positions and/or tool placements, for each expert and for each stage. The present system can determine a group average position for each joint position and/or tool placement for each stage, based on the averaged locations. For example, the present system can determine a standard deviation for the data recorded for an expert during a stage or segment. The present system can then determine an aggregate zone of accuracy based on the average locations and on the standard deviation. For example, the present system can determine a height, width, and depth of an aggregate zone of accuracy as three standard deviations from the center of the averaged location.

The present system also determines aggregate paths based on joint positions of the one or more experts based on the sensor data of the experts (step 514). As described earlier, the present system can identify joint positions and tool placements (both in 2D and 3D space) for each expert at the same point during a procedure, for example by correlating when the experts complete a stage or segment. The present system can identify joint paths and/or tool paths for each stage in a procedure. For each joint path and/or tool path, the present system identifies differences in technique between experts (step 516).

In some embodiments, the present system can also label the variances, for later identification or standard setting.

The present system then provides a performance model, based on the aggregate zones of accuracy and on the aggregate paths (step 518). As described earlier, in some embodiments, the performance model can include zones of accuracy, joint paths, and/or tool paths. For example, the present system can create zones of accuracy for the performance model as follows. The present system can determine a group average position for each point within a stage or segment of a procedure, using the average positions for each point from the subject matter experts. As described earlier, the present system can determine a standard deviation of the average positions from the experts. Based on the standard deviation, the present system can define a height, width, and depth for a zone of accuracy for the performance model as three standard deviations from the center of the group average position. The present system can determine joint paths and/or tool paths as follows. Using the identified paths for each expert, the present system can determine a group average path within a stage or segment of a procedure, based on the joint paths and/or tool paths from the experts. In some embodiments, the joint paths and/or tool paths can also be determined based on external sources. A non-limiting example of an external source includes external published metrics of validated ergonomic data such as for a safe patient handling procedure. In some embodiments, the joint paths and/or tool paths can include measurements of position over time. The present system can then compare slopes of joint paths and/or tool paths from users, to determine how frequently the paths from the users matched the paths from the experts.

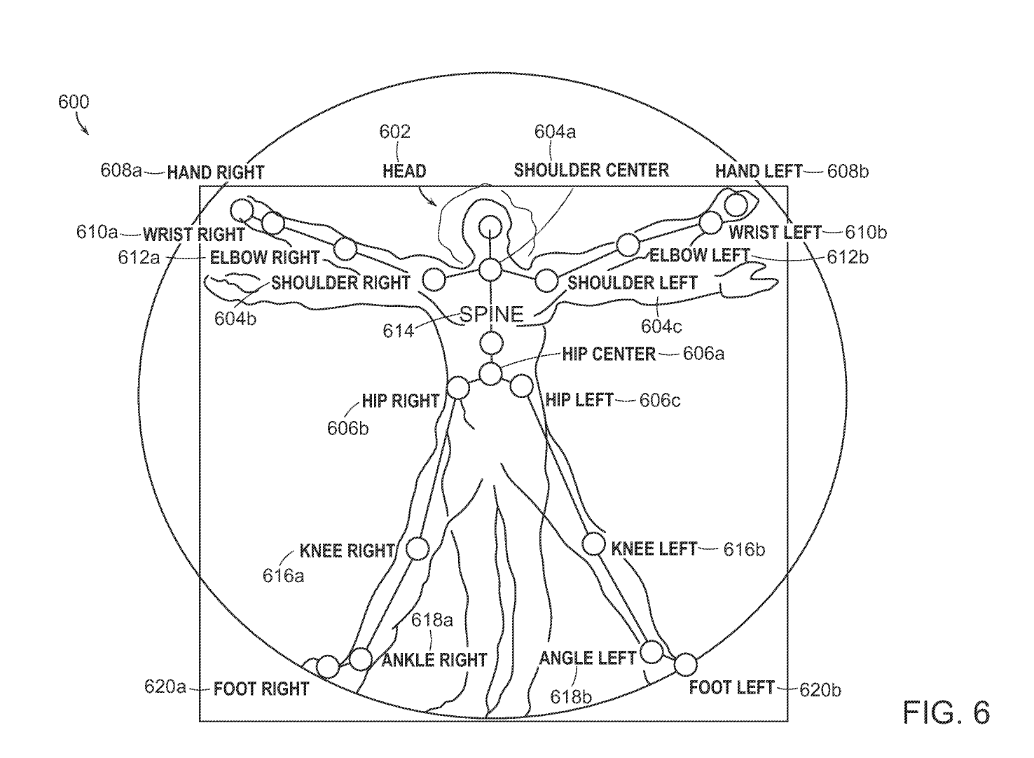

FIG. 6 illustrates an example of sensor data that the system obtains while a procedure is performed in accordance with certain embodiments of the present disclosure. As illustrated in FIG. 6, example sensor data 600 can include body position data. For example, the present system can obtain a position or motion of the user's head 602, shoulder center 604a, shoulder right 604b, or shoulder left 604c. Further examples of performance data representing body position can include obtaining a position or motion of the user's spine 614, hip center 606a, hip right 606b, or hip left 606c. Additional examples of performance data can include obtaining a position or motion of the user's hand right 608a or hand left 608b, wrist right 610a or wrist left 610b, or elbow right 612a or elbow left 612b. Further examples of performance data representing body position can include obtaining a position or motion of the user's knee right 616a or knee left 616b, ankle right 618a or ankle left 618b, or foot right 620a or foot left 620b. In some embodiments, the present system can retrieve the sensor data using a software development kit (SDK), application programming interface (API), or software library associated with the motion-sensitive camera. In some embodiments, the motion-sensitive camera can be capable of capturing twenty joints while the user is standing and ten joints while the user is sitting.

FIG. 7 illustrates an example of performance data that the system determines while a procedure is performed in accordance with certain embodiments of the present disclosure. Performance data measures a user's performance based on sensor data from the motion-sensitive camera. In some embodiments, performance data can include body tracking performance data 702, finger articulation performance data 706, object recognition performance data 710, and zone validation performance data 712. Body tracking performance data 702 allows users to learn improved motion accuracy 704 from the present system. Finger articulation performance data 706 allows users to learn improved placement accuracy 708 from the present system. Zone validation performance data 712 allows users to lower expected times 714 to completion. As described earlier in connection with FIG. 2B, in some embodiments, zone recognition allows the present system to recognize general zones for determining on a coarse level a location of a user's joints and/or instrument. Zone recognition allows the present system to evaluate whether the user's hands and/or instrument are located in a generally correct area. In some embodiments, color recognition allows the present system to coordinate spatial aspects between similarly colored areas. For example, the present system can determine whether a yellow end of a tool is close to a mannequin's chin colored yellow.

Further examples of performance data can include skeleton positions in (x,y,z) coordinates, skeletal joint positions in (x,y,z) coordinates, color position in (x,y) coordinates, color position with depth in (x,y,z) coordinates, zone validation, time within a zone, time to complete a stage or segment, time to complete a lesson or training module including multiple stages or segments, time to fulfill a requirement set by an instructor, and/or various paths. Zone validation can refer to a position within specified 2D and/or 3D space. Non-limiting example paths can include persistent color position paths, skeleton position paths, and skeleton joint paths. Persistent color position paths refer to paths created by tracking masses of pixels regarding predefined colors over time from within the physical space. Persistent color position paths can determine interaction with zones of accuracy, angle of approach, applied force, order of execution regarding instrument handling and identification of the instrument itself in relative motion comparison to other defined objects and instruments within the physical environment. Skeleton position paths and skeleton joint paths refer to paths created to determine body mechanics of users tracked over time per stage, and validation of update accuracy for a current stage and procedure.

Through experimentation, the sensor data from the motion-sensitive camera was found to contain random inconsistencies in the ability to map accurately to the user at all times during the motion capture process. The present system is able to refine the sensor data to alleviate these inconsistencies. For example, the present system can determine performance data based on the sensor data by joint averaging of joints from the sensor data (to lock a joint from jumping in position or jittering, while keeping a consistent joint-to-joint measurement), joint-to-joint distance lock of joints from the sensor data (upon occlusion, described later), ignoring joints from the sensor data that are not relevant to the training scenario, and “sticky skeleton” (to avoid the user's skeleton from the sensor data jumping to other individuals within line of sight to the motion-sensitive camera). Joint averaging refers to comparing a user's previously measured joint positions to the user's current position, at every frame of sensor data. Joint-to-joint distance lock refers to determining a distance between neighboring joints (for example, during initial calibration). If a view of a user is later obscured, the present system can use the previously determined distance to track the user much more accurately than a traditional motion-sensing camera. Ignoring joints refers to determining that a joint is “invalid” based on inferring a location of the joint that fails the joint-to-joint distance lock comparison, determining that a joint's position as received from the sensor data from the motion-sensing camera is an extreme outlier during joint averaging, determining based on previous configuration that a joint is unimportant for the current stage or segment or procedure, or if the joint belongs to a virtual skeleton of another user. Sticky skeleton refers to latching on to a virtual skeleton of a selected user or set of users throughout a procedure, to minimize interference based on other users in view of the motion-sensing camera who are not to be tracked or not participating in the training session.

Other non-limiting examples of determining performance data based on the sensor data include determining zones of accuracy 712 (to measure time to completion 714), determining finger articulation 706 (to measure intricate finger placement/movements 708), and/or color tracking/object recognition 710 (to identify and track an optional instrument, tool, or prop used in the training scenario). Determination of zones of accuracy 712 and color tracking/object recognition 710 has been described earlier. The present system determines finger articulation based on color blob detection, focusing on color tracking of a user's skin color, and edge detection of the resulting data. The present system finds a center point of the user's hand by using triangulation from the wrist joint as determined based on the sensor data. The present system then determines finger location and joint creation based on the results of that triangulated vector using common placement, further validated by edge detection of each finger. Based on this method of edge detection, and by including accurate depth information as described earlier, the present system is able to determine clearly the articulation of each finger by modeling the hand as virtual segments that are then locked to the movement of the previously generated hand joints. In some embodiments, the present system uses twenty-seven segments for modeling the user's hand. The locked virtual segments and hand joint performance data is then exploited to track articulation of the hand over a sequence of succinct frames.

In some embodiments, color tracking 710 also identifies interaction with zones of accuracy and provides an accurate way to collect motion data of users wielding optional instruments to create a visual vector line-based path for display in a user interface. For example, the present system can display the visual vector line-based path later in a 3D results panel (shown in FIG. 15) to allow the user or an administrator to do a comparison analysis between the user's path taken and the defined path of mastery.

In some embodiments, the present system is able to determine performance data with accuracy to a centimeter, millimeter, or nanometer. Advantageously, the present system is able to determine performance data with significantly improved accuracy, e.g., millimeter accuracy, than the measurements available through standard software libraries, software development kits (SDKs), or application programming interfaces (APIs) for accessing sensor data from the motion-sensing camera. Determination of performance data using sensor data received from the motion-sensing camera is described in further detail later, in connection with FIG. 7.

In some embodiments, the present system is able to determine performance data based on monitoring the user's movement and display output results when only a portion of the user is visible to the motion-sensitive camera. For example, if the user is standing behind the mannequin and operating table, the motion-sensitive camera can likely only see an upper portion of the user's body. Unlike traditional motion-sensitive camera systems, the present system is able to compensate for the partial view and provide feedback to the user. For example, the present system can use other previously collected user calibration data to lock joints in place when obscured. Because the present system has already measured the user's body and assigned joints at determined areas, the measurement between those pre-measured areas is “locked,” or constant, in the present system. Therefore, if a limb is directed at an angle with a joint obscured, a reference to the initial joint measurement is retrieved, applied and locked to the visible joint until the obscured joint becomes visible again. For example, the present system may know a distance (C) between two objects (A, B) that can only change angle, but not length. If object (A) becomes obscured, the present system can conclude that the position of obscured object (A) will be relative to the angle of visible object (B) at the unchanging length (C).

Additional performance data representing body position determined based on sensor data received from the motion-sensing camera can include height, weight, skeleton size, simulation device location, and distance to the user's head. An example of simulation device location can include a location of a mannequin's head, such as for training procedures including intubation. In further embodiments, the present system can determine additional performance data based on performance data already determined. For example, the present system can determine performance data for height of a user, as (height of a user=simulation device location+distance to the user's head), in which simulation device location and distance to the user's head represent performance data already determined as described earlier. The present system can also determine skeleton size of a user, as (skeleton size=(shoulder left-shoulder center)+(shoulder right-shoulder center)), in which shoulder left, shoulder center, and shoulder right represent performance data already determined as described earlier. Similarly, the present system can also determine performance data for weight of a user, as (weight of a user=skeleton size+height) in which skeleton size and height represent performance data determined as described earlier. In some embodiments, the present system is able to determine performance data with accuracy to a centimeter, millimeter, or nanometer based on sensor data received from the motion-sensing camera.

In some embodiments, performance data can include measures of depth. The present system is able to provide significantly more accurate measures of depth (i.e., z-coordinate) than traditional motion-sensing camera systems. This improved accuracy is achieved as the present system improves measures of performance data including depth according to the following process. The present system uses color tracking to determine an (x,y) coordinate of the desired object. For example, the present system can use sensor data received from the motion-sensing camera including a color frame image. The present system iterates through each pixel in the color frame image to gather hue, chroma, and saturation values. Using the gathered values, the present system determines similarly colored regions or blobs. The present system uses the center of the largest region as the (x,y) coordinate of the desired object. The present system then receives sensor data from the motion-sensing camera including a depth frame image corresponding to the color frame image. The present system maps or aligns the depth frame image to the color frame image. The present system is then able to determine the desired z-coordinate, by retrieving the z-coordinate from the depth frame image that corresponds to the (x,y) coordinate of the desired object from the color frame image.

In some embodiments, performance data can also include measurements of physics. For example, the present system can determine performance data such as motion, speed, velocity, acceleration, force, angle of approach, or angle of rotation of relevant tools. In some embodiments, performance data can include measurements relative to the simulation training device. For example, the present system can indirectly determine force applied by various handheld tools to the mannequin during an intubation procedure. The present system is able to measure performance data to determine the amount of force applied to a handheld device for prying open a simulation mannequin's mouth during an intubation procedure. If a user is applying too much force, the present system can alert the user either in real-time as the user performs the procedure, or at the completion of the procedure.

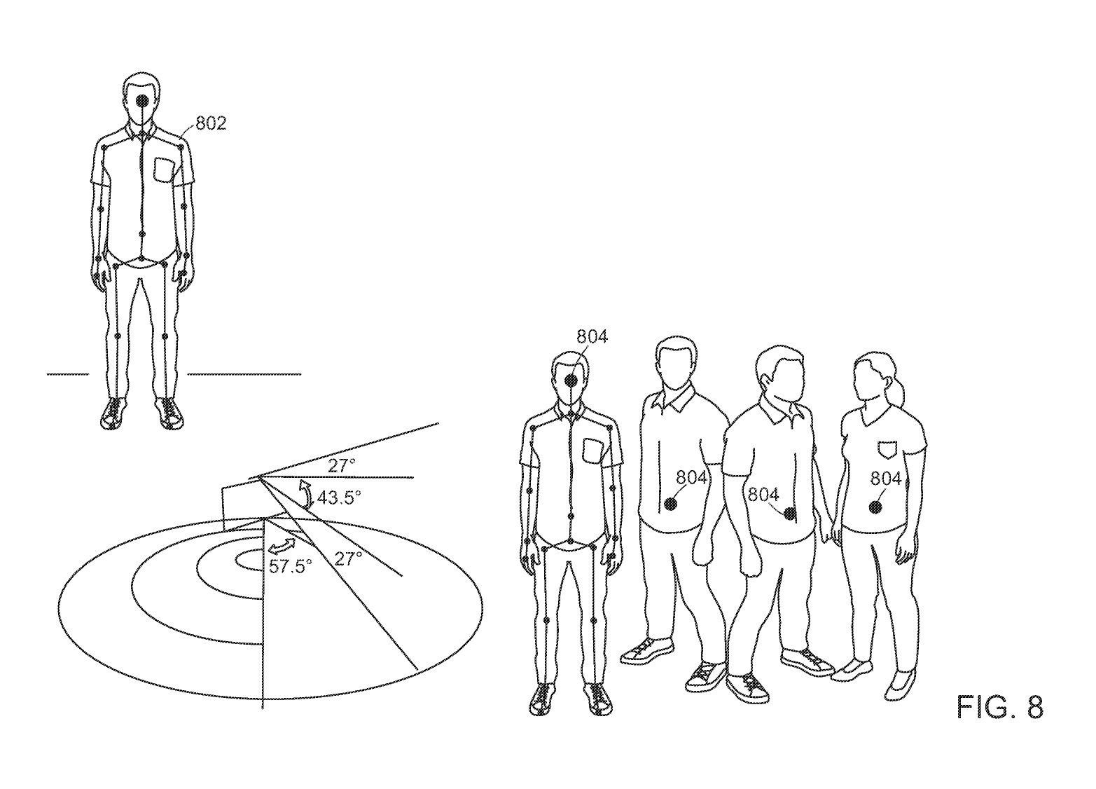

FIG. 8 illustrates an example of tracking multiple users in accordance with certain embodiments of the present disclosure. The present system allows configuration of multiple users 804. Examples of performance data 802 tracked for multiple users can include body position performance data, and/or any performance data described above in connection with FIG. 7. For example, the present system can monitor two users who work concurrently in coordinated action to perform a safe patient handling procedure by carrying multiple ends of a patient on a stretcher. Coordinated actions of all workers are needed to insure safe handling of a patient. The present system is also capable of detecting up to six users for a particular training module and switching between default and near mode as appropriate for the scenario. Default mode refers to tracking the skeleton of two users within a scene, when the users were originally calibrated in near mode. Near mode refers to traditional two-user calibration which can be performed by the motion-sensing camera. As described earlier, the present system includes the ability to divide the user's physical space into depth-based zones of accuracy where users are expected to be during specific parts of the training exercise. The present system can also determine performance data based on a “sticky skeleton” capability to switch the tracking skeleton to any user at any position within the physical space. This “sticky skeleton” capability improves upon traditional capabilities of the motion-sensing camera to switch from an initial calibrated user to any user that is closest to the screen.

The present system determines a performance metric of a procedure based on the performance data described earlier. In some embodiments, the present system compares the performance data with a performance model. The performance model can measure performances by experts (shown in FIGS. 5A-5B). For example, the comparison can be based on determining deviations from the performance model, as compared with the performance data. Example deviations can include deviating from a vertical position compared with the performance model, deviating from a horizontal position compared with the performance model, deviating from an angle of approach or an angle of rotation of certain tools compared with the performance model, or deviating from a distance of joints compared with the performance model. In some embodiments, the present system can determine a performance metric by multiplying together each deviation measurement. Of course, the present system may combine deviation measurements in many ways, including adding deviation measurements, averaging deviation measurements, or taking weighted averages of deviation measurements.

The present system determines performance metrics as follows. As described earlier, the present system determines performance data of a user based on sensor data collected and recorded from a motion-sensitive camera. The present system determines performance metrics by evaluating performance data to determine accuracy. These performance metrics can include evaluating a user's order of execution relative to instrument handling, evaluating a user's static object interaction, evaluating a user's intersections of 3D zones of accuracy, and evaluating states of a user's joint placement such as an end state. Furthermore, the present system can determine performance metrics based on tracking interim data between the user's end states per stage. For example, the present system can determine performance metrics including evaluating a user's angle of approach for color tracked instruments and selected joint-based body mechanics, evaluating a vector path of user motion from beginning to end of stage as per designated variable (color, object or joint), evaluating time-to-completion from one stage to another as per interaction with 3D “stage end state” zones, evaluating interaction with multiple zones of accuracy that define a position held for a set period of time but are only used as a performance variable to be factored before the end state zone is reached, evaluating physical location over time of users in a group (such as in coordinated functional procedures including safe patient handling), evaluating verbal interaction between users (individual, user-to-user), evaluating instrument or static object interaction between users in a group, and evaluating time to completion for each user and the time taken for the entire training exercise.

Based on the performance metrics, the present system may output results such as alerting the user to improper movement, either while the user is performing the procedure or after the user has finished performing the procedure. Examples of improper movement may include a user's action being too fast, too slow, not at a proper angle, etc. Advantageously, the improved accuracy of the present system allows common errors to be detected more frequency than by traditional methods. For example, using traditional methods an evaluator may not notice an incorrect movement that is off by a few millimeters. Due to its improved accuracy, the present system is able to detect and correct such improper movements.

### Example User Interaction with AIMS

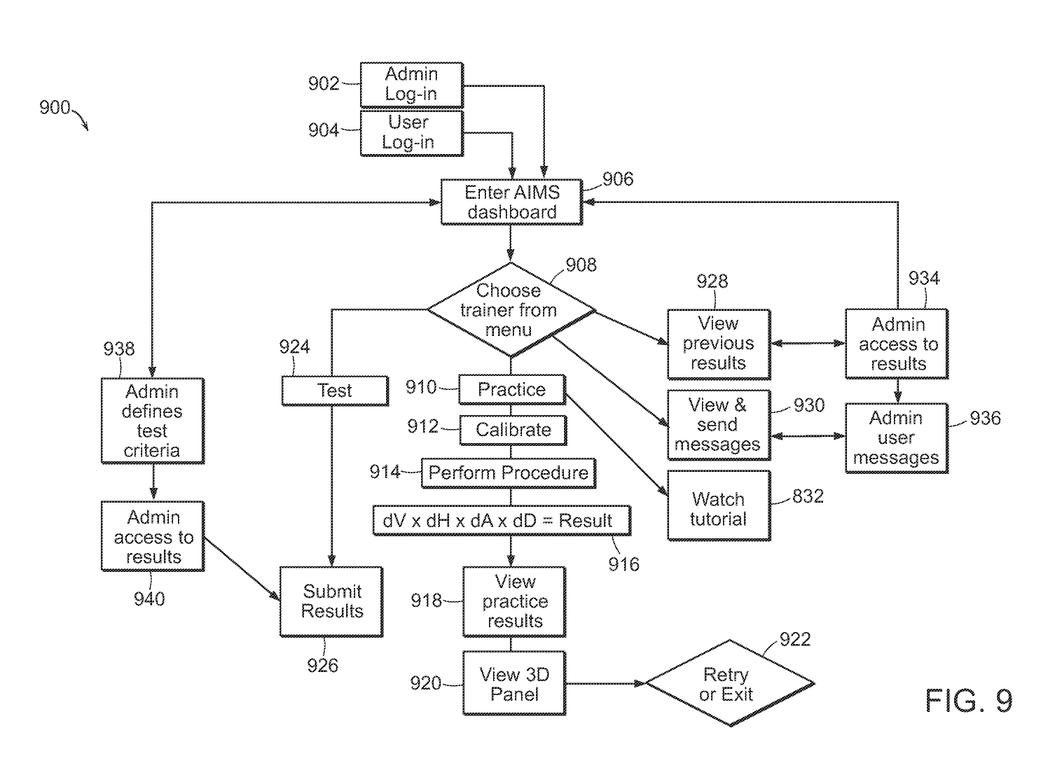

FIG. 9 illustrates an example of a method 900 that the system performs for evaluating performance of a procedure in accordance with certain embodiments of the present disclosure. The present system supports multiple types of accounts, such as user accounts, instructor accounts, and administrator accounts. Of course, the present system may support more or fewer types of accounts as well.

For a user account, the present system first receives a login from the user (step 904). In some embodiments, the login can include using a secure connection such as secure sockets layer (SSL) to transmit a username and password. In further embodiments, the password can be further secured by being salted and one-way hashed. The present system displays an AIMS dashboard (step 906). The present system receives a user selection of a training module from a menu (step 908). Example modules can include endotracheal intubation by direct laryngoscopy, safe patient lifting, or any other training module that evaluates performance of a procedure by a user. After receiving a user selection of a training module, the present system allows a user to select to practice (step 910), take a test (step 924), view previous results (step 928), or view and send messages (step 930).

If a user chooses to practice (step 910), the present system begins with calibration (step 912). Optionally, the user can elect to watch a tutorial of the procedure (step 932). As described earlier, calibration allows a user to follow instructions on the display to prepare the present system to evaluate performance of a procedure. For example, the present system can determine the user's dimensions and range of motion in response to certain instructions.

The present system monitors the user performing the procedure (step 914). In some embodiments, the present system can divide a procedure into segments. Each segment can assist the user by including a figure or other depiction indicating how the operation should be performed. For example, at the beginning of a training session, the present system may display a picture of a user picking up a medical device, and/or text instructing the user to pick up the medical device. Of course, the present system may also provide audible instructions. As the user performs each segment or stage, the present system obtains performance data representing the user's interactions. The performance data can represent speed and/or accuracy with which the user performed each segment or stage. With reference to FIG. 2, exemplary feedback for stages 1-10 is shown with respect to the user's angle of approach to the mannequin.

The monitoring includes obtaining performance data based on the sensor data received from the motion-sensing camera (shown in FIGS. 6 and 7). The present system determines a performance metric of the procedure (step 916). As described earlier, the present system can offload determination of a performance to a cloud-based system. In some embodiments, the cloud-based system can be a Software as a Service (SaaS) implementation that meets legal requirements such as the Health Insurance Portability and Accountability Act (HIPAA), the Health Information Technology for Economic and Clinical Health (HITECH) Act, and/or the Family Educational Rights and Privacy Act (FERPA). The present system determines performance metrics based on the performance data obtained earlier. In some embodiments, the present system compares the performance data with a performance model. The performance model can measure performances by experts (shown in FIGS. 5A-5B). For example, the comparison can be based on determining a deviation from the performance model compared with the performance data. Example deviations can include deviating from a vertical position compared with the performance model, deviating from a horizontal position compared with the performance model, deviating from an angle of approach or an angle of rotation of certain tools compared with the performance model, or deviating from a distance of joints compared with the performance model. In some embodiments, the present system can determine a performance metric by multiplying together each deviation measurement. Of course, the present system may combine deviation measurements in many ways, including adding deviation measurements, averaging deviation measurements, or taking weighted averages of deviation measurements.

As the user is performing the procedure, the present system outputs results of the practice session (step 918). The present system can output results while the user is performing the procedure, such as in a feedback loop, or after the user has completed the procedure. In some embodiments, the present system can output results onto a 3D panel or otherwise provide a 3D view on the display (step 920). A 3D panel or 3D depiction on a display can provide an interactive viewer to allow a user to rotate a replay segment of the procedure in a substantially 360° view. As described earlier, in some embodiments the output results can also include data charts reflecting a date on which the training exercise was attempted, and skill mastery or performance metrics attained per segment or stage. In some embodiments, the output results can also include line graphs that display segment or stage accuracy of the previous training exercise, and time-to-completion of the previous training exercise. In further embodiments, the line graphs can include a histogram of progress over time, and overall skill mastery over time. In some embodiments, the present system can leverage sensor data from multiple motion-sensing cameras to improve the accuracy of 3D review.

In some embodiments, the present system outputs results by displaying relevant zones while a user is performing the procedure. For example, the present system can display zones in colored overlays as the user is performing the procedure, to provide further guidance to the user.

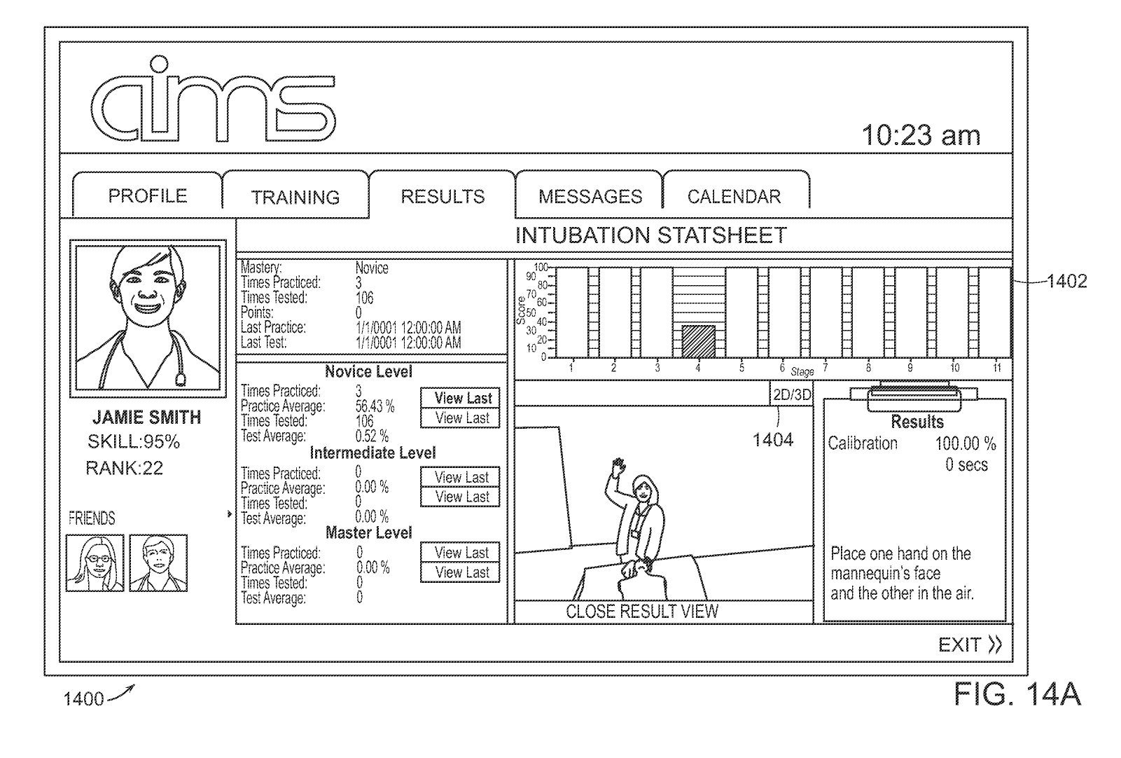

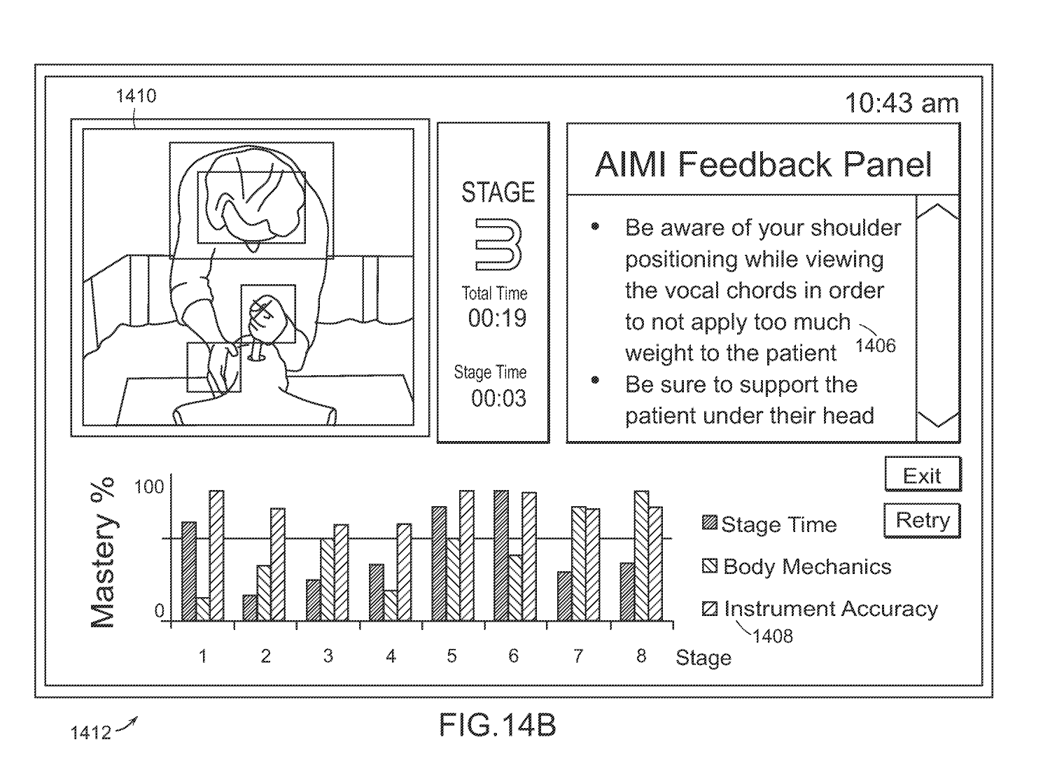

Finally, the present system can receive a user selection to retry the training module or exit (step 922). In some embodiments, the present system can require a user to submit results in order to try again or exit the training simulation. Once that function is complete and the user exits, the present system can display a “Results” page (shown in FIGS. 14A-14B). The “Results” page allows a user to review her performance data over time to observe her ascent to achieving procedural mastery. In some embodiments, once a user completes the task training exercise or procedure, the user may view his or her results in a multitude of graphical representations. Example graphical representations can include a 2D panel with zone overlay, a 3D panel with “user path taken” vs. “path of mastery” Bezier curves, detailed feedback for each stage, a summary of the users performance via a virtual assistant, and a graph such as a bar graph showing a success rate for each stage or segment of the task training exercise or procedure.

If the user selects to take a test (step 924), the present system can determine and output results such as a combined score and/or a respective score for each segment based on the performance metric. A user can select to submit results of the test (step 926). In some embodiments, the test results can be aggregated and displayed on a scoreboard. For example, rankings can be based on institution and/or country. Example institutions can include hospitals and/or medical schools. Rankings can also be determined per procedure and/or via an overall score per institution.

The present system also allows the user to view previous results (step 928) and/or view and/or send messages (step 930). The present system allows the user to view previous results by rewinding to a selected segment, and watching the procedure being performed to see where the user made mistakes. The present system allows the user to view and/or send messages to other users, or to administrators. The present system allows an instructor or administrator to provide feedback to and receive feedback from students in messages.

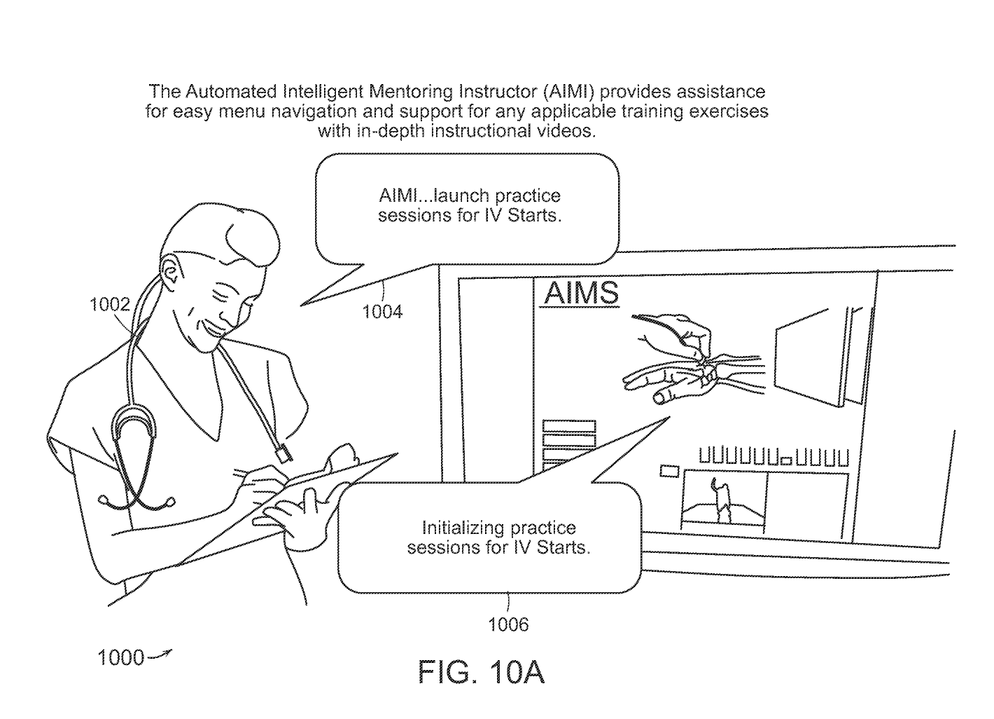

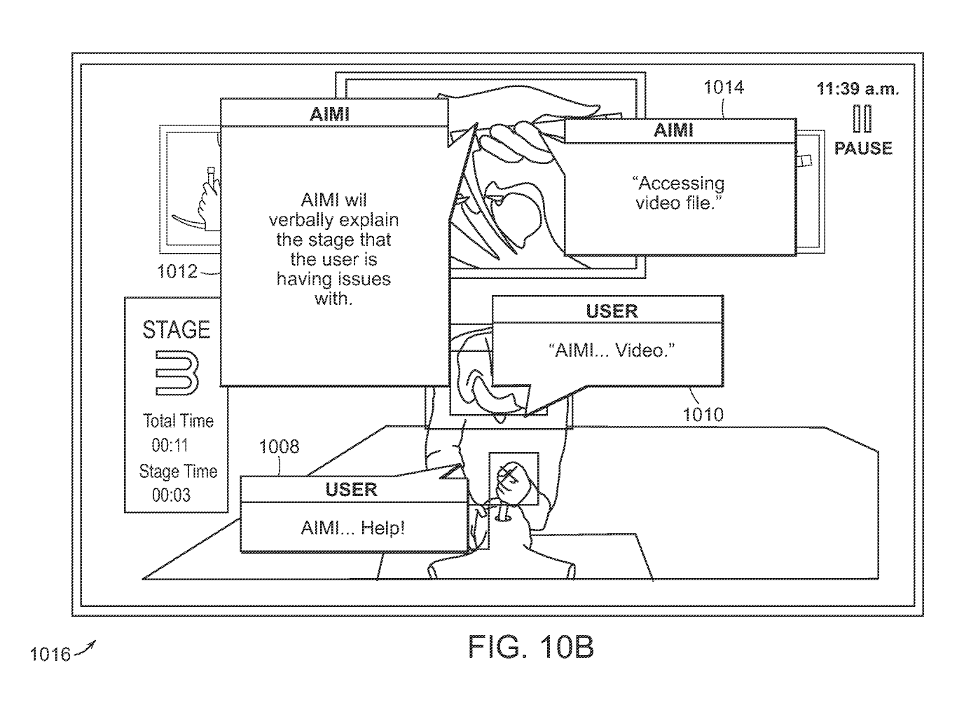

FIGS. 10A-10B illustrate example screenshots of a user interface 1000 for interacting with the system in accordance with certain embodiments of the present disclosure. As illustrated in FIG. 10A, user interface 1000 can include a user 1002 and a virtual assistant. In some embodiments, the virtual assistant can be referred to as an Automated Intelligent Mentoring Instructor (AIMI). The virtual assistant can assist with menu navigation and support for applicable training exercises or training modules with available instructional videos. The virtual assistant can help the user navigate through the interface, provide feedback, and show helper videos. In some embodiments, the feedback can include immediate feedback given during training based on the performance data and performance metrics, and/or summary analysis when training simulation is complete. For example, user 1002 can speak an instruction 1004, such as “ABM . . . launch practice session for IV starts.” The virtual assistant can load training exercises and/or training modules for an intravenous (IV) start procedure. The virtual assistant can confirm receipt of the command from user 1002 with a response 1006, such as “initializing practice session for IV Starts.”

As illustrated in FIG. 10B, an example user interface 1016 can include spoken commands 1008, 1010 and spoken responses 1012, 1014. Of course, as described earlier, the commands and responses can also be implemented as visual input and output. For example, a user can speak a command 1008 such as “AIMI . . . Help!” A virtual assistant in the present system can provide response 1012 such as “AIMI will verbally explain the stage that the user is having issues with.” Similarly, the user can speak a command 1010 such as “AMR . . . Video!” The present system can provide response 1014 such as “[a]ccessing video file.” The present system can then proceed to play on the display a video file demonstrating a model or expected performance of the current stage or segment of the procedure.

FIG. 11 illustrates an example screenshot of a user interface for calibrating the system in accordance with certain embodiments of the present disclosure. For example, the user interface can include a real-time video feed 1102 and a corresponding avatar 1104. In some embodiments, the present system can be calibrated prior to obtaining performance data from various devices or task trainers. For example, the present system can be calibrated to compensate for particular model brands or model variation among motion-sensing cameras.

For example, the present system can instruct the user to raise a hand, as shown in real-time video feed 1102 and reflected in avatar 1104. The present system can determine a wire frame around the user to determine the user's dimensions and measurements. As described earlier in connection with FIG. 7, performance data such as skeletal frame measurements can be used to estimate a height and average weight of the user. These measurements can be used to calculate a range of motion and applied force over the duration of the training exercise. In some embodiments, all calculations are measured in millimeters against a predefined zone of the training model. The predefined zone of the training model can be set to (x=0,y=0,z=0) at initial calibration. As illustrated in FIG. 10, in some embodiments calibration can be performed directly in front of any simulation training devices, to obtain correct skeletal frame measurements of the trainee, user, or student.

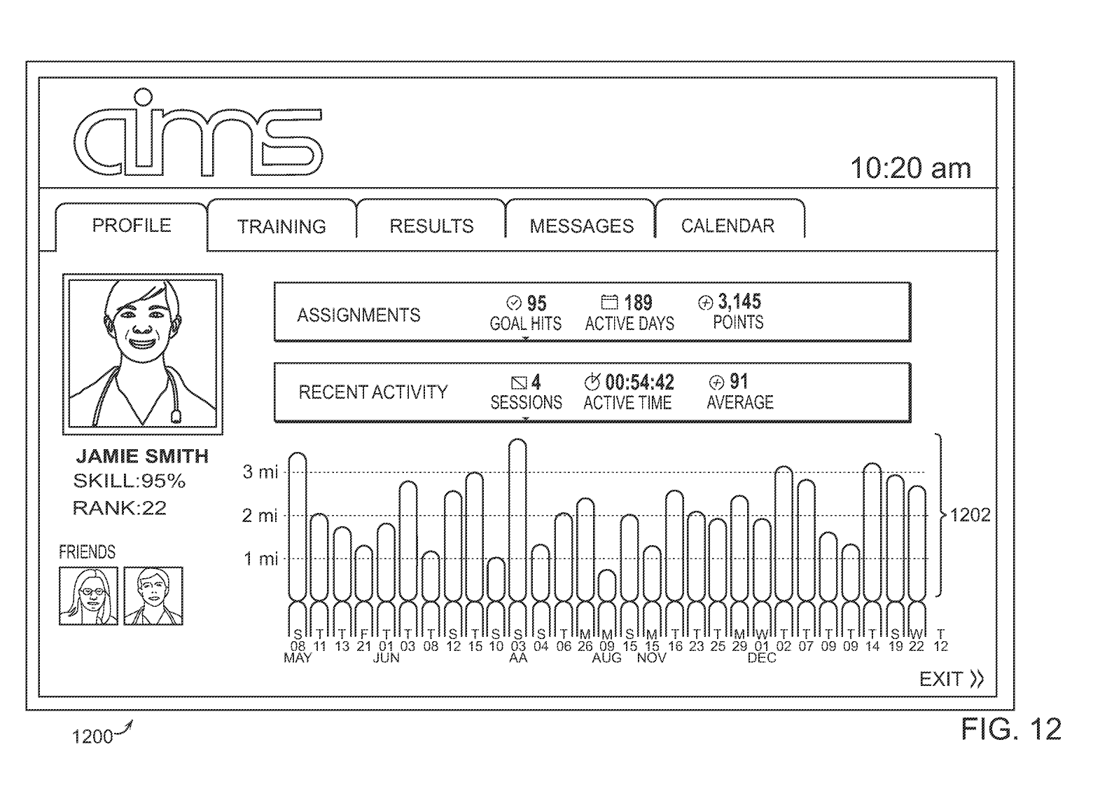

FIG. 12 illustrates an example screenshot of a user interface 1200 for displaying a student profile accordance with certain embodiments of the present disclosure. For example, user interface 1200 can include a bar graph 1202 of student performance for various days of the week. Bar graph 1202 can output results such as a number of workouts the student has performed, a duration of time for which the student has used the present system, and a number of calories the student has expended while using the present system.

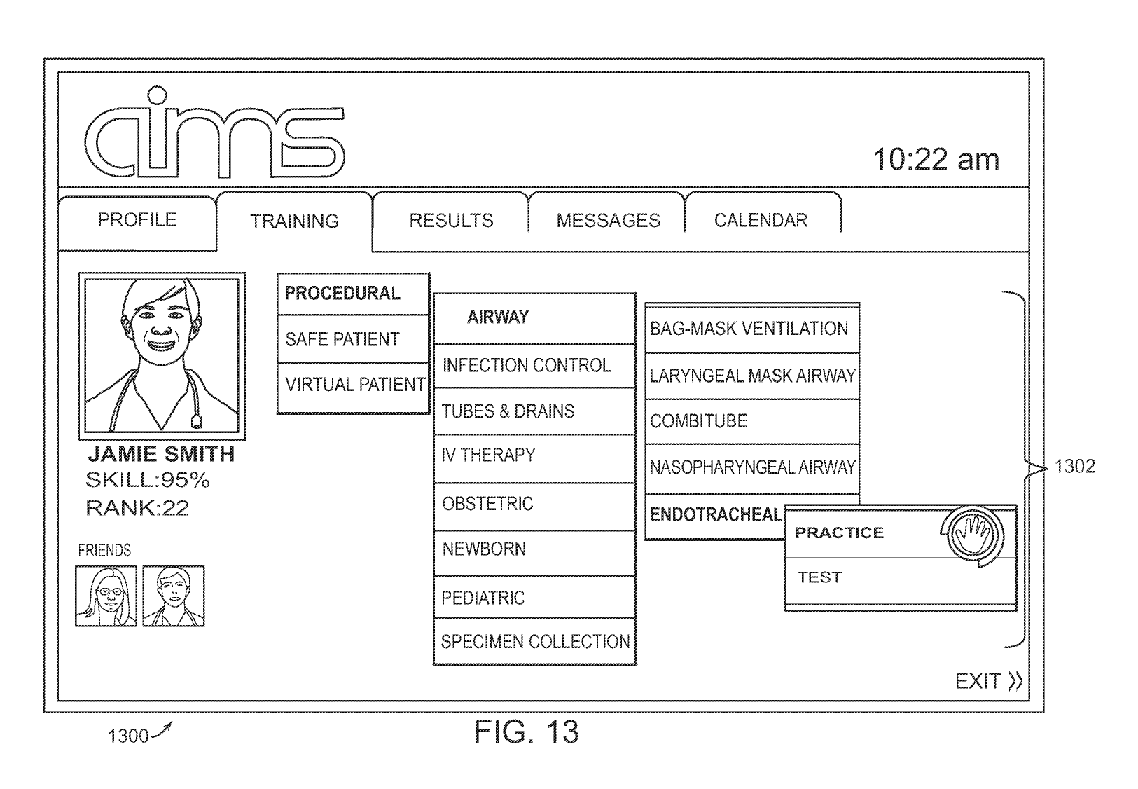

FIG. 13 illustrates an example screenshot of a user interface 1300 for selecting a training module in accordance with certain embodiments of the present disclosure. For example, user interface 1300 can include a listing 1302 of procedures. As illustrated in listing 1302, the present system supports training students or users on procedures, safe patient handling, and virtual patients. If a user selects to train on procedures, the user interface can display procedure categories such as airway, infection control, tubes and drains, intravenous (IV) therapy, obstetric, newborn, pediatric, and/or specimen collection. If the user selects the airway procedure category, the user interface can display available training modules or procedures such as bag-mask ventilation, laryngeal mask airway insertion, blind airway insertion such as Combitube, nasopharyngeal airway insertion, and/or endotracheal intubation. For each procedure, the user can select to practice the procedure or take a test in performing the procedure.

FIGS. 14A-B illustrate example screenshots of user interfaces for reviewing individual user results in accordance with certain embodiments of the present disclosure. As illustrated in FIG. 14A, user interface 1400 can include a bar graph 1402 of the user's score per stage or segment of a procedure or training module, and a result view of the user's previous performance. The result view can include a previously recorded video feed of the user. As described earlier, in some embodiments the “Results” page allows a user to review her performance data over time to observe her ascent to achieving procedural mastery. Once a user completes the task training exercise or procedure, the user may view his or her results in a multitude of graphical representations. Example graphical representations can include a 2D panel with zone overlay, a 3D panel with “user path taken” versus “path of mastery” Bezier curves, detailed feedback for each stage, a summary of the users performance via a virtual assistant, and a graph such as a bar graph showing a success rate for each stage or segment of the task training exercise or procedure. For example, 2D/3D button 1404 can allow the user to toggle between a 2D result view and a 3D result view.

As illustrated in FIG. 14B, a non-limiting example user interface 1412 can include a feedback panel 1406 which instructs the user on considerations for a certain stage or segment of the procedure. For example, feedback panel 1406 can include feedback such as “[b]e aware of your shoulder positioning while viewing the vocal cords in order to not apply too much weight to the patient,” or “[b]e sure to support the patient under their head.” User interface 1412 can also include a bar graph 1408 of mastery or progress through all stages of a procedure. For example, the bar graph can display performance metrics including stage time, body mechanics, and instrument accuracy. User interface 1412 can also display a real-time video feed 1410 including previously evaluated zones of accuracy.

### Example Administrator Interaction with AIMS

As described earlier, the present system supports administrator accounts in addition to user accounts. With reference to FIG. 9, the present system can receive a login from an administrator (step 902). The present system allows an administrator to view previous results of users who have attempted procedures or training modules (step 934). For example, an administrator can navigate to review graphical analytic data for a number of classes, a single class, a select group of students from various classes, or a single student. An administrator can follow students' progress and assess problem areas needing addressing. The present system also allows an administrator to view and/or send messages from users or other administrators (step 936). The present system allows an administrator to disable a reply function, for example if the administrator and/or instructor prefers to avoid receiving an overflow of feedback from users or students.

After a user has completed testing, the present system allows an administrator to define test criteria (step 938). The present system then applies the test criteria against the user's performance. The present system also allows an administrator to access prior test results from users (step 940).

FIG. 15 illustrates a screenshot of an example user interface 1500 for a course snapshot administrator view for a procedure in accordance with certain embodiments of the present disclosure. For example, user interface 1500 can include participants 1502 and visualizations of their respective mastery scores 1504. An administrator can use a hand cursor 1506 or other pointer to select an individual mastery score to view an individual participant overview.

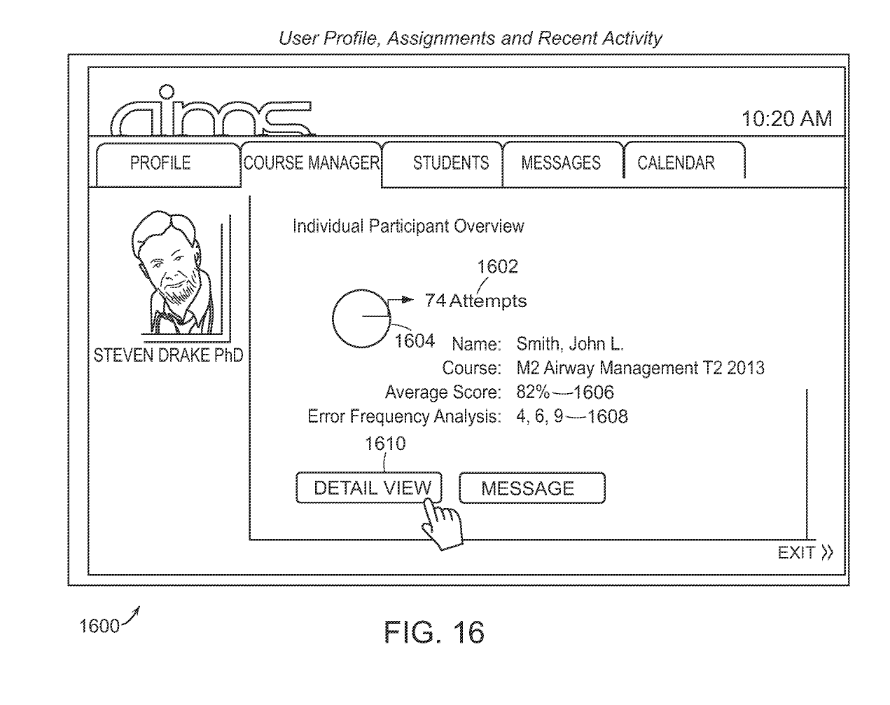

FIG. 16 illustrates a screenshot of an example user interface 1600 for an individual participant overview administrator view for a procedure in accordance with certain embodiments of the present disclosure. For example, user interface 1600 can display performance metrics for an individual participant. Non-limiting example performance metrics can include a count of the number of attempts 1602 the user has practiced the procedure (e.g., the Airway Management procedure). User interface 1600 can also display performance metrics including a visualization 1604 of the user's performance when practicing the procedure. User interface 1600 can also display performance metrics including an average score 1606 (e.g., 82%), and an error frequency analysis 1608. Error frequency analysis 1608 can illustrate stages or segments in which an individual participant's most frequent errors arise (e.g., stages 4, 6, and 9). User interface 1600 can also include a Detail View button 1610 to view an individual participant detail view.

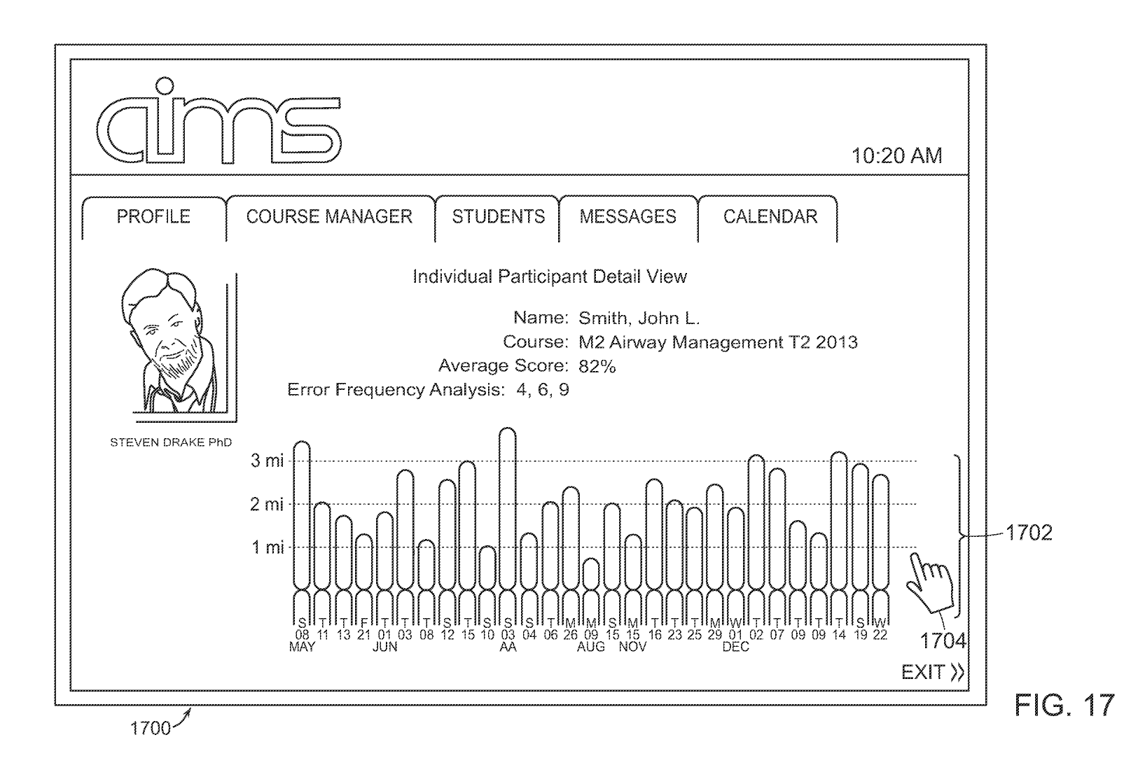

FIG. 17 illustrates a screenshot of an example user interface 1700 for an individual participant detail view administrator view for a procedure in accordance with certain embodiments of the present disclosure. For example, user interface 1700 can illustrate more detailed information about the individual participant's performance in a procedure (e.g., the Airway Management procedure). The user interface can include a bar graph 1702 of the individual participant's results over time, for example per day. An administrator can use a hand cursor 1704 or other pointer to select an individual event to enter an individual event detail for the selected event.

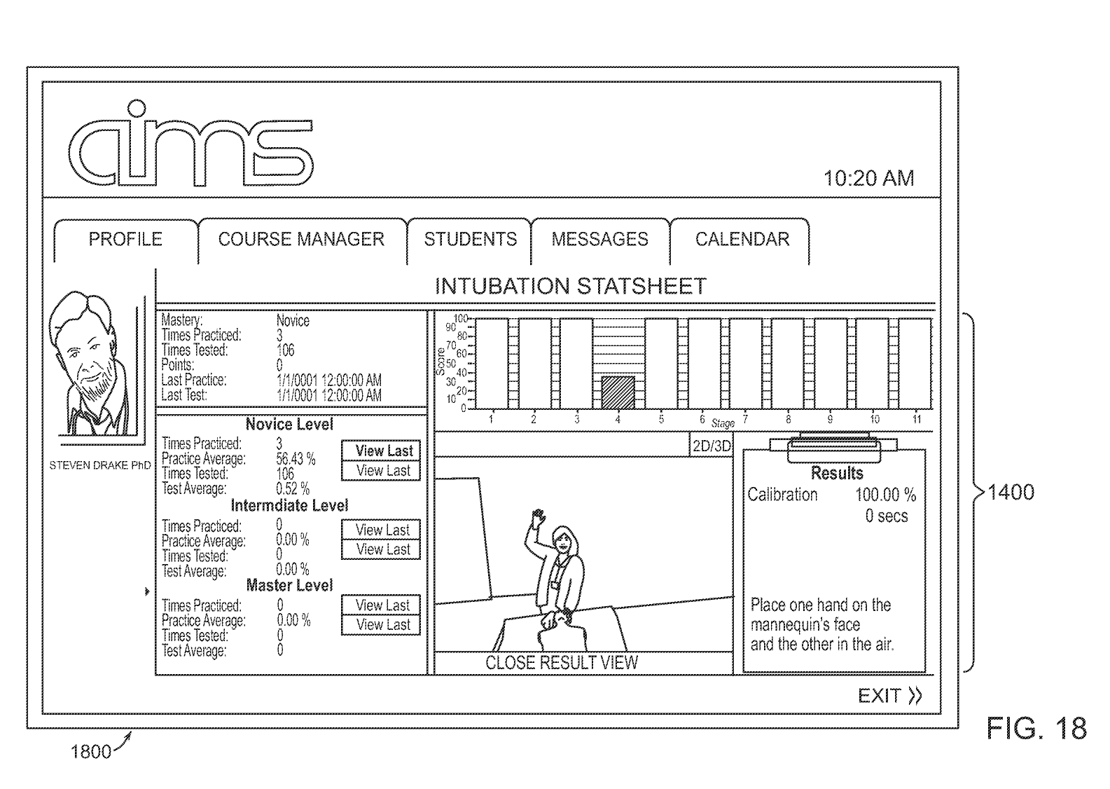

FIG. 18 illustrates a screenshot of an example user interface 1800 for an individual event detail view administrator view for a procedure in accordance with certain embodiments of the present disclosure. For example, user interface 1800 can include an embedded view of an individual results pane 1400.

Standard Setting

In some embodiments, the present system can determine a standard or model way of performing a procedure by aggregating performance data from many users and/or subject matter experts each performing a procedure. A non-limiting example process of determining performance data is described earlier, in connection with FIG. 4. In some embodiments, the present system allows administrators to leverage data or observations learned based on providing a performance model of performances by subject matter experts. For example, when providing a performance model, the present system may determine that nearly all subject matter experts perform a procedure in a way that is different from what is traditionally taught or described, for example in textbooks. In some instances, a subject matter expert or group of subject matter experts may handle a tool or device at a particular angle, such as fifteen degrees, while a textbook may describe that the tool should be held at forty degrees. The present system allows for unexpected discoveries and subsequent setting or revising of relevant standards. Similarly, historical data tracked by the present system can be leveraged for unexpected discoveries, such as determining how often a learner or student needs to practice procedures by repetition to achieve mastery, or determining how long a student can go between practices to retain relevant information.

In other embodiments, the present system can allow an administrator to categorize movements in a segment or procedure as “essential” or “non-essential.” The present system can leverage its ability to determine absolute x, y, z measurements of real-time human performance, including the time required for or taken by individual procedure steps and sequencing, and apply relevant sensor data, performance models, and performance to determine objective assessment of procedural skills. The ability and precision described herein represents a substantial improvement over traditional methods, which rely principally on subjective assessment criteria and judgment rather than the objective measurement available from the present systems and methods. Traditional evaluation methods can include many assumptions regarding the effectiveness of described procedural steps, techniques, and sequencing of events. The real-time objective measurement of performance provided by the present system can provide significant information, insight and guidance to refine and improve currently described procedures, tool and instrument design, and procedure sequencing. For example, the present system can help determine standards such as determination of optimal medical instrument use for given clinical or procedural situations (e.g., measured angles of approach, kinesthetic tactual manipulation of patients, instruments and devices, potential device design modifications, or verification of optimal procedural sequencing). The present system may further provide greater objective measurement of time in deliberate practice and/or repetitions required. These greater objective measurements may help inform accrediting bodies, licensing boards, and other standards-setting agencies and groups, such as the US Occupational Safety and Health Administration (OSHA), the National Institute for Occupational Safety and Health (NIOSH) and the Joint Commission on Accreditation of Healthcare Organizations (JCAHO) of relative required benchmarks as quality markers.

The present systems and methods can be applied to any procedural skill. Non-limiting example procedural skills can include medical procedures including use of optional devices, functional medical procedures without involving use of devices, industrial procedures, and/or sports procedures. Non-limiting examples of medical procedures including use of optional devices can include airway intubation, lumbar puncture, intravenous starts, catheter insertion, airway simulation, arterial blood gas, bladder catherization, incision and drainage, surgical airway, injections, joint injections, nasogastric tube placement, electrocardiogram lead placement, vaginal delivery, wound closure, and/or venipuncture. Non-limiting examples of functional medical procedures without involving use of devices can include safe patient lifting and transfer, and/or physical and occupational therapies. Non-limiting examples of industrial procedures can include equipment assembly, equipment calibration, equipment repair, and/or safe equipment handling. Non-limiting examples of sports procedures can include baseball batting and/or pitching, golf swings and/or putts, and racquetball, squash, and/or tennis serves and/or strokes.

What is claimed is:

1. A computer-implemented method for evaluating performance of a procedure, the method comprising:
providing a performance model of a procedure, the performance model based at least in part on one or more previous performances of the procedure;
obtaining performance data while the procedure is performed, the performance data based at least in part on sensor data received from one or more motion-sensing devices;
determining a performance metric of the procedure, the performance metric determined by comparing the performance data with the performance model; and
outputting results, the results based on the performance metric.

2. The method of claim 1, wherein the determining the performance model includes aggregating data obtained from monitoring actions from multiple performances of the procedure.

3. The method of claim 1, wherein
the performance data includes user movements;
the sensor data received from the one or more motion-sensing devices includes motion in at least one of an x, y, and z direction received from a motion-sensing camera; and
the comparing the performance data with the performance model includes determining deviations of the performance data from the performance model.

4. The method of claim 1, wherein the obtaining the performance data includes receiving sensor data based on a position of a simulation training device, the simulation training device including a medical training mannequin.

5. The method of claim 1, wherein the obtaining the performance data includes receiving sensor data based on a relationship between two or more people.

6. The method of claim 1, wherein the obtaining the performance data includes determining data based on a user's upper body area while the user's lower body area is obscured.

7. The method of claim 1, wherein the procedures include at least one of endotracheal intubation by direct laryngoscopy, intravenous starts, bladder catheter insertion, arterial blood collection for blood gas measurement, incision and drainage, cutaneous injections, joint aspirations, joint injections, lumbar puncture, nasogastric tube placement, electrocardiogram lead placement, tendon reflex assessment, vaginal delivery, wound closure, venipuncture, safe patient lifting and transfer, physical and occupational therapies, equipment assembly, equipment calibration, equipment repair, safe equipment handling, baseball batting, baseball pitching, golf swings, golf putts, racquetball strokes, squash strokes, and tennis strokes.

8. A system for evaluating performance of a procedure, the system comprising:
one or more motion-sensing devices for providing sensor data tracking performance of a procedure;
one or more displays;
storage; and
at least one processor configured to:
provide a performance model of a procedure, the performance model based at least in part on one or more previous performances of the procedure;
obtain performance data while the procedure is performed, the performance data based at least in part on the sensor data received from the one or more motion-sensing devices;
determine a performance metric of the procedure, the performance metric determined by comparing the performance data with the performance model; and
output results to the display, the results based on the performance metric.

9. The system of claim 8, wherein the at least one processor configured to determine the performance model includes the at least one processor configured to aggregate data obtained from monitoring actions from multiple performances of the procedure.

10. The system of claim 8, wherein
the performance data includes user movements;
the sensor data received from the one or more motion-sensing devices includes motion in at least one of an x, y, and z direction received from a motion-sensing camera; and
the at least one processor configured to compare the performance data with the performance model includes the at least one processor configured to determine deviations of the performance data from the performance model.

11. The system of claim 8, wherein the at least one processor configured to obtain the performance data includes the at least one processor configured to receive sensor data based on a position of a simulation training device, the simulation training device including a medical training mannequin.

12. The system of claim 8, wherein the at least one processor configured to obtain the performance data includes the at least one processor configured to receive sensor data based on a relationship between two or more people.

13. The system of claim 8, wherein the at least one processor configured to obtain the performance data includes the at least one processor configured to determine data based on a user's upper body area while the user's lower body area is obscured.

14. The system of claim 8, wherein the procedures include at least one of endotracheal intubation by direct laryngoscopy, intravenous starts, bladder catheter insertion, arterial blood collection for blood gas measurement, incision and drainage, cutaneous injections, joint aspirations, joint injections, lumbar puncture, nasogastric tube placement, electrocardiogram lead placement, tendon reflex assessment, vaginal delivery, wound closure, venipuncture, safe patient lifting and transfer, physical and occupational therapies, equipment assembly, equipment calibration, equipment repair, safe equipment handling, baseball batting, baseball pitching, golf swings, golf putts, racquetball strokes, squash strokes, and tennis strokes.

15. A non-transitory computer program product for evaluating performance of a procedure, the non-transitory computer program product tangibly embodied in a computer-readable medium, the non-transitory computer program product including instructions operable to cause a data processing apparatus to:
provide a performance model of a procedure, the performance model based at least in part on one or more previous performances of the procedure;
obtain performance data while the procedure is performed, the performance data based at least in part on sensor data received from one or more motion-sensing devices;
determine a performance metric of the procedure, the performance metric determined by comparing the performance data with the performance model; and
output results, the results based on the performance metric.

16. The non-transitory computer program product of claim 15, wherein the instructions operable to cause the data processing apparatus to determine the performance model include instructions operable to cause the data processing apparatus to aggregate data obtained from monitoring actions from multiple performances of the procedure.

17. The non-transitory computer program product of claim 15, wherein
the performance data includes user movements;
the sensor data received from the one or more motion-sensing devices includes motion in at least one of an x, y, and z direction received from a motion-sensing camera; and
the instructions operable to cause the data processing apparatus to compare the performance data with the performance model include instructions operable to cause the data processing apparatus to determine deviations of the performance data from the performance model.

18. The non-transitory computer program product of claim 15, wherein the instructions operable to cause the data processing apparatus to obtain the performance data include at least one of (i) instructions operable to cause the data processing apparatus to receive sensor data based on a position of a simulation training device, the simulation training device including a medical training mannequin, and (ii) instructions operable to cause the data processing apparatus to receive sensor data based on a relationship between two or more people.

19. The non-transitory computer program product of claim 15, wherein the instructions operable to cause the data processing apparatus to obtain the performance data include instructions operable to cause the data processing apparatus to determine data based on a user's upper body area while the user's lower body area is obscured.

20. The non-transitory computer program product of claim 15, wherein the procedures include at least one of endotracheal intubation by direct laryngoscopy, intravenous starts, bladder catheter insertion, arterial blood collection for blood gas measurement, incision and drainage, cutaneous injections, joint aspirations, joint injections, lumbar puncture, nasogastric tube placement, electrocardiogram lead placement, tendon reflex assessment, vaginal delivery, wound closure, venipuncture, safe patient lifting and transfer, physical and occupational therapies, equipment assembly, equipment calibration, equipment repair, safe equipment handling, baseball batting, baseball pitching, golf swings, golf putts, racquetball strokes, squash strokes, and tennis strokes.
